(19) United States
(12) Patent Application Publication
(10) Pub. No.: US 2006/0110132 A1
(43) Pub. Date: May 25, 2006

(54) Information recording medium, information recording device and method, information reproduction device and method, information recording/reproduction device and method, recording or reproduction control computer program, and data structure containing control signal

(76) Inventors: Nobuyuki Takakuwa, Saitama (JP); Yasuko Fukuda, Saitama (JP); Takao Sawabe, Saitama (JP); Tohru Kanegae, Saitama (JP); Masanori Nakahara, Saitama (JP); Takeshi Koda, Saitama (JP); Akira Imamura, Saitama (JP)

Correspondence Address: YOUNG & THOMPSON, 745 SOUTH 23RD STREET, 2ND FLOOR, ARLINGTON, VA, 22202, US

(21) Appl. No.: 10/529,865

(22) PCT Filed: Oct. 1, 2003
(86) PCT No.: PCT/JP03/12579

§ 371 Date: Oct. 18, 2005

(30) Foreign Application Priority Data
Oct. 1, 2002 (JP) 2002-288255

(51) Int. Cl. H04N 7/08

(52) U.S. Cl. 386/95

(57) ABSTRACT

An information record medium is provided with: a content space in which a plurality of content domains are recorded, each content domain being constructed from a series of content information; and a system space in which a plurality of menu domains corresponding to the plurality of content domains are recorded, each menu domain being constructed from menu information as for the content information. Another menu domain is recorded in the system space, in addition to the plurality of menu domains, the another menu domain being constructed from menu information as for whole of the plurality of content domains or as for whole of the information record medium.

### TECHNICAL FIELD

The present invention relates to: an information record medium, such as a high-density optical disc, on which various information can be recorded at high density, such as main picture information or video information, audio information, sub picture information, and reproduction control information; an apparatus for and a method of recording the information onto the information record medium; an apparatus for and a method of reproducing the information from the information record medium; an apparatus and a method capable of both recording and reproducing the information, a computer program for controlling the recording or the reproduction, and a data structure including a control signal for controlling the reproduction.

### BACKGROUND ART

According to a DVD in a so-called “DVD video standard”, a plurality of title domains (TT_DOM), provided with a series of content information, and a title set menu domain (VTSM_DOM), controlling a menu of the plurality of title domains, are recorded in a Video Title Set space (VTS_Space). Here, the “series of content information” indicates the video information, the audio information, the sub picture information, and the like, which constitute one title, such as one show and one movie, for example. It is recorded in the VTS space as the title domain. Moreover, the menu in the title domain is to select or set whether the subtitle of a show, constituting one title, is English or Japanese, for example, or to select or set an angle if the angle can be reproduced, and the like. It is recorded in the VTS space as a menu domain corresponding to each title. In short, a title menu domain is to individually set in what condition each title will be reproduced, or is being reproduced. Moreover, the “space” is a unit of record information in a record area, which corresponds to a treatment unit in a reproduction operation with a player.

A disc menu about a plurality of VTS spaces or the entire disc is recorded in a Video ManaGer space (VMG_Space), recorded in a different area from the VTS space in the record area on the disc, as a VMG menu domain (VMGM_DOM). Here, the “disc menu” is to select or set whether the audio of on the entire disc is Japanese or English, for example, or to select or set a title menu in the disc, and the like. It is recorded in the VMG space, as the VMG menu domain which is a common menu domain in the entire disc. In short, the VMG menu domain is to integrally or collectively set in what condition every title will be reproduced, or is being reproduced.

Moreover, the VTS space and the VGM space being “recorded in different areas”, means that the VTS and VGM spaces are recorded in the record area such that the domain recorded in the VTS space and the domain recorded in the VMG space cannot be changed and reproduced, at the same time or immediately, or such that the domains cannot be reproduced in parallel.

### DISCLOSURE OF INVENTION

However, as described above, since the VTS space and the VMG space are recorded in different areas on the information record medium, in order to reproduce the VMG space, such as calling the disc menu, for example, during reproduction in the VTS space, such as during title reproduction and title menu reproduction, it is required that after the reproduction of the VTS space is canceled and then an optical pickup is displaced into the VMG space, reading processing and reproduction processing in the VMG space are started. Moreover, after the start of the reproduction in the VMG space, the data read in the VTS space is eliminated, in principle. In the same manner, after the start of the reproduction in the VTS space, the data read in the VMG space is eliminated, in principle. In addition, even various system parameters set for a DVD player are also eliminated or initialized, along with a reproduction transition between the domains.

Consequently, the reproduction transition cannot be arbitrarily performed between the title domain and the menu domain, which is disadvantageous and inconvenient for a user. On the contrary, in order to attain the reproduction transition between the title domain and the menu domain, it needs the complexity of a reading operation on the player. Moreover, there is a technical problem that it is basically difficult to perform the quick reproduction transition or change operation.

It is therefore an object of the present invention to provide: an information record medium which enables a simple and quick reproduction transition between a menu domain constructed from menu information as for the whole of the information record medium, such as a disc menu about the entire DVD, and a menu domain constructed from title menu information effective for each title, in reproducing the information on a DVD player, for example; an apparatus for and a method of recording the information onto the information record medium; an apparatus for and a method of reproducing the information from the information record medium; an apparatus for and a method of recording and reproducing the information, a computer program for controlling the recording or the reproduction, and a data structure including a control signal for controlling the reproduction.

An information record medium of the present invention is provided with: a content space in which a plurality of content domains are recorded and which occupies one area in a recording area of the information record medium, each content domain being constructed from a series of content information; and a system space in which a plurality of menu domains corresponding to the plurality of content domains are recorded and which occupies a different area from the content space in the recording area, each menu domain being constructed from menu information as for the content information, another menu domain being recorded in the system space, in addition to the plurality of menu domains, the another menu domain being constructed from menu information as for whole of the plurality of content domains or as for whole of the information record medium.

According to the information record medium of the p resent invention, the content space in which the plurality of content domains are recorded and the system space in which the plurality of menu domains are recorded occupy different areas in the recording area. Such a plurality of menu domains are those associated with the content domain, such as an individual title, which is being reproduced; for example, there is listed a menu operation for changing audio and a video angle, and the like, in the reproduction of the content domain in the content space. Here, particularly, another menu domain, such as the disc menu, is recorded in the system space, in addition to the plurality of menu domains. The another menu domain is constructed from the menu information as for the whole of the plurality of content domains or as for the whole of the information record medium. The menu domain, such as the disc menu as described above, is the menu domain associated with the whole of the information record medium; for example, there is listed a menu operation for performing the display of all the titles, audio selection and setting (e.g. speaker arrangement setting in an audio surround system), the change and setting of audio languages, the change and setting of subtitle languages, and the like, which is common to all the titles on the disc.

Therefore, in the reproduction of the information record medium, in order to reproduce the menu domain associated with the content domain which is being reproduced during the reproduction of the content domain in the content system, the reproduction transition may be performed from the content space to the system space, to thereby reproduce the menu domain. Alternatively, even in order to reproduce the menu domain associated with the whole of the information record medium which is being reproduced during the reproduction of the content domain as described above, the reproduction transition may be performed from the content space to the system space in the same manner, to thereby reproduce the menu domain. Particularly, even in reproducing the menu domain associated with the whole of the information record medium during the reproduction of the menu domain associated with the content domain which is being reproduced, it is enough if the reproduction transition is performed in the same system space.

Thus, it is possible to perform the reproduction transition between the content domains in the content space, the reproduction transition between the menu domains in the system space, and particularly, the reproduction transition between the menu domain associated with the individual content in the system space and the menu domain associated with the whole of the information record medium, quickly and easily. For example, in an information reproduction apparatus, it is possible to perform the reproduction transition between the disc menu associated with the whole of the disc and the title menu associated with the individual title, easily and quickly. Such reproduction transition is performed in the same system space with regard to the processing of the information reproduction apparatus. Thus, such a processing load is reduced that is related to the elimination and discard or destruction of a system parameter, the reading and setting of new control information, and the like, as compared to the case of the conventional DVD described above. Thus, it is relatively easy to display any one of the menu domains in a condition that the content information which is being reproduced is temporarily stopped, perform the setting and change of the system parameter of the information reproduction apparatus, and then restart the temporarily stopped content information.

As described above, according to the information record medium of the present invention, for example, in reproducing the information on a DVD player or the like, it is possible to perform the reproduction transition between the menu domain which is constructed from the menu information as for the whole of the information record medium, such as the disc menu about the entire DVD, and the menu domain which is constructed from the title menu effective for each title, easily and quickly.

In one aspect of the information record medium of the present invention, a content domain for first play, which is reproduced in an initial stage of a reproduction operation, is further recorded in the system space.

According to this aspect, in the reproduction, at first, the content domain for the first play, which is recorded in the system space, is reproduced in the initial stage of the reproduction operation. For example, at first, a screen which shows general information, such as the producer or author, distribution company, and the like of the information record medium, and the like are unconditionally reproduced, in response to the insertion of the information record medium into the information reproduction apparatus. Then, following this, the easy and quick reproduction transition can be performed with respect to the menu domain which is the disc menu or the like, and the menu domain which is the title menu or the like, recorded in the system space in the same manner.

In another aspect of the information record medium of the present invention, the content information is multiplexed and recorded by a unit of packet, which is a physically accessible unit and by which a piece of the content information is individually stored, as the content domain.

According to this aspect, the content information is multiplexed and recorded by the unit of packet in the content space, and this constitutes the content domain. The reproduction in the content space is performed by reproducing the content information by such a unit of packet through the reproduction processing, such as demultiplexing and decoding. On the other hand, in the system space, the menu domain is not necessarily multiplexed and recorded by the unit of packet, and the menu domain may be collectively recorded by a unit larger than the packet unit in a predetermined area in the recording area. Alternatively, in the system space, the menu domain may be constructed by multiplexing and recording the menu information by the unit of packet, as in the content information.

In another aspect of the information record medium of the present invention, the menu information as for the whole is constructed from information for commonly performing selection or setting regarding a plurality of video information or audio information, which constitutes the content information, on the whole of the information record medium.

According to this aspect, even during the reproduction of the content domain, the reproduction transition to the system space is performed, and the menu domain as for the whole, such as the disc menu, is displayed. In this condition, it is possible to commonly perform the selection or the setting regarding the video information or the audio information, such as the selection of audio languages, audio selection, the display and selection of all the titles, and the like, on the whole of the information record medium.

In another aspect of the information record medium of the present invention, the menu information as for the content information is constructed from information for performing selection or setting regarding a plurality of video information or audio information, which constitutes the content information, only with respect to the content information.

According to this aspect, even during the reproduction of the content domain, the reproduction transition to the system space is performed, and the menu domain about the content domain which is being reproduced or whose reproduction is temporarily stopped, or the menu domain about another content domain, such as the title menu, is displayed. In this condition, it is possible to perform the selection or the setting regarding the video information or the audio information, such as the change of audio languages, the change of angles, and the like, only with respect to the content domain which is being reproduced or whose reproduction, or another content domain.

In another aspect of the information record medium of the present invention, a plurality of titles recorded on the information record medium individually comprise one of the content domains and one of the menu domains, and one of the plurality of titles comprises the another menu domain and a content domain for first play.

According to this aspect, all the domains can be treated in a unified manner, and it is possible to collectively store the information at one position on the record medium. Thus, it is possible to obtain the information in the reproduction, relatively easily.

An information record apparatus of the present invention is provided with: a first recording device for recording a plurality of content domains into a content space which occupies one area in a recording area of an information record medium, each content domain being constructed from a series of content information; and a second recording device for recording a plurality of menu domains corresponding to the plurality of content domains into a system space which occupies a different area from the content space in the recording area, each menu domain being constructed from menu information as for the content information, the second recording device recording another menu domain into the system space, in addition to the plurality of menu domains, the another menu domain being constructed from menu information as for whole of the plurality of content domains or as for whole of the information record medium.

According to the information record apparatus of the present invention, the first recording device which is made of a controller, an encoder, a TS object generator as described later, an optical pickup, a cutting device, and the like, records the plurality of content domains, such as a plurality of titles, into the content space which occupies one area in the recording area of the information record medium, such as a DVD. For example, the second recording device which is made of a controller, an encoder, a TS object generator as described later, an optical pickup, a cutting device, and the like, records the plurality of menu domains, such as the title menu, corresponding to the plurality of content domains, into the system space which occupies a different area from the content space in the recording area of the information record medium. In addition to the menu domains, the second recording device records another menu domain into the system space. The another menu, such as the disc menu, is constructed from menu information as for the whole of the plurality of content domains or as for the whole of the information record medium.

Therefore, it is possible to record the information relatively efficiently onto the above-described information record medium of the present invention (including its various aspects).

Incidentally, the information record apparatus of the present invention can also adopts various aspects in response to various aspects of the above-described information record medium of the present invention.

An information record method of the present invention is provided with: a first recording process of recording a plurality of content domains into a content space which occupies one area in a recording area of an information record medium, each content domain being constructed from a series of content information; and a second recording process of recording a plurality of menu domains corresponding to the plurality of content domains into a system space which occupies a different area from the content space in the recording area, each menu domain being constructed from menu information as for the content information, the second recording process recording another menu domain into the system space, in addition to the plurality of menu domains, the another menu domain being constructed from menu information as for whole of the plurality of content domains or as for whole of the information record medium.

According to the information record method of the present invention, by using a controller, an encoder, a TS object generator as described later, an optical pickup, a cutting device, and the like, the first recording process records the plurality of content domains, such as a plurality of titles, into the content space which occupies one area in the recording area of the information record medium, such as a DVD. The second recording process records the plurality of menu domains, such as the title menu, corresponding to the plurality of content domains, into the system space which occupies a different area from the content space in the recording area of the information record medium. In addition to the menu domains, the second recording process records another menu domain into the system space. The another menu, such as the disc menu, is constructed from menu information as for the whole of the plurality of content domains or as for the whole of the information record medium.

Therefore, it is possible to record the information relatively efficiently onto the above-described information record medium of the present invention (including its various aspects).

Incidentally, the information record method of the present invention can also adopts various aspects in response to various aspects of the above-described information record medium of the present invention.

An information reproduction apparatus of the present invention is an information reproduction apparatus for reproducing information on the above-described information record medium of the present invention (including its various aspects), the information reproduction apparatus provided with: a reproducing device for reproducing the content domain from the content space and reproducing the plurality of menu domains or the another menu domain from the system space; a setting device capable of externally setting a system parameter correspondingly to the reproduced plurality of menu domains or the reproduced another menu domain; and a controlling device for controlling the reproducing device to reproduce the content domain, in accordance with the system parameter externally set by the setting device.

According to the information reproduction apparatus of the present invention, the reproducing device which is made of a controller, a decoder, a demultiplexer, an optical pickup, and the like, reproduces the content domain form the content space, in accordance with the operation in which a remote control or the like is used by a user. Alternatively, the reproducing device reproduces the plurality of menu domains, such as the title menu, or the another menu domain, such as the disc menu, from the system space, in accordance with the operation in which a remote control or the like is used by a user. By the user operation corresponding to the reproduction of the menu domains as described above, the system parameter corresponding to the menu domain is externally set through the setting device, such as a remote control and an operation panel. Then, the controlling device controls the reproducing device to reproduce the content domain or domains, in accordance with the system parameter externally set.

Therefore, it is possible to reproduce the information relatively efficiently on the above-described information record medium of the present invention (including its various aspects).

Incidentally, the information reproduction apparatus of the present invention can also adopts various aspects in response to various aspects of the above-described information record medium of the present invention.

In one aspect of the information reproduction apparatus of the present invention, the system parameter includes: one or a plurality of first system parameters, which are set correspondingly to the plurality of menu domains; one or a plurality of second system parameters, which are set correspondingly to the another menu domain; and a third system parameter for indicating a content domain which is a setting object of the first system parameter.

According to this aspect, by the user operation corresponding to the reproduction of the menu domains, for example, through the setting device, such as a remote control and an operation panel, the first system parameter or parameters are set correspondingly to the plurality of menu domains, such as the title menu, and the second system parameter or parameters are set correspondingly to the another menu domain, such as the disc menu. Moreover, the third system parameter for indicating a content domain which is the setting object of the first system parameter is set. Thus, by using the first to third system parameters set correspondingly to the reproduction of the menu domains, it is possible to perform the reproduction processing, such as the subsequent reproduction of the content domain.

In this aspect, the third system parameter may indicate that the first system parameter is not set, by virtue of its particular value.

By virtue of such a construction, the information reproduction apparatus can judge that the first system parameter is not set, if referring to the third system parameter. Thus, it is possible to prevent the situation that the content domain is reproduced in accordance with the ineffective first system parameter, and the situation that it is tried to read the first system parameter which is not set.

In another aspect of the information reproduction apparatus of the present invention, the second system parameter includes a resume flag for indicating whether or not the second system parameter is changed in the another menu domain if the reproduction of the content domain is restarted by resume reproduction, and the controlling device controls the reproducing device to perform the resume reproduction of the content domain, on the basis of the resume flag.

According to this aspect, the information reproduction apparatus can easily judge whether or not the second system parameter is changed, with respect to the content domain which is being reproduced or whose reproduction is temporarily stopped, if referring to the resume flag included in the second system parameter. Under the control of the controlling device, the reproducing device can perform the resume reproduction in accordance with the second system parameter in which the content domain is changed. Incidentally, such a resume flag may indicate whether or not the second system parameter is set.

Incidentally, the “resume reproduction” indicates that after the reproduction of the content information which is being reproduced is temporarily stopped and the system parameter is changed on the menu, the reproduction of the content information is restarted from where the reproduction is temporarily stopped. With respect to the content information whose reproduction is temporarily stopped in the process of the resume reproduction, the content information displayed at the stop time is displayed as a still picture and used as a background, and a menu screen by the menu domain may be transparently displayed or window-displayed.

In another aspect of the information reproduction apparatus of the present invention, the system parameter further includes a fourth system parameter for indicating a content domain which is being currently reproduced by the reproducing device, and the controlling device controls the reproducing device to reproduce the content domain on the basis of the first system parameter, if the content domain indicated by the third system parameter agrees with the content domain indicated by the fourth system parameter.

According to this aspect, in accordance with the reproduction of the content domain, the fourth system parameter is regularly or irregularly updated so as to indicate the content domain which is being reproduced. If the content domain which is indicated by the third system parameter and which is the setting object of the first system parameter agrees with the currently reproduced content domain indicated by the fourth system parameter, the first system parameter is to be effective for the currently reproduced content domain. Thus, in this case, the controlling device controls the reproducing device to reproduce the content domain on the basis of the first system parameter. As a result, the reproduction is performed in the audio language and the video angle which are set in the title menu and which are indicated by the first system parameter.

On the contrary, if the currently reproduced content domain indicated by the fourth system parameter does not agree with the content domain which is indicated by the third system parameter and which is the setting object of the first system parameter, the first system parameter is not to be effective for the currently reproduced content domain. Thus, in this case, the controlling device controls the reproducing device to reproduce the content domain, not on the basis of the first system parameter, but on the basis of the second system parameter which provides default, for example. As a result, the reproduction is performed in the audio language and the video angle which are set in the disc menu and which are indicated by the second system parameter of the default condition.

An information reproduction method of the present invention is an information reproduction method of reproducing information on the above-described information record medium of the present invention (including its various aspects) on an information reproduction apparatus provided with: a reproducing process of reproducing the content domain from the content space and reproducing the plurality of menu domains or the another menu domain from the system space; and a controlling process of controlling the reproducing process to reproduce the content domain, in accordance with a system parameter externally set by the setting device capable of externally setting the system parameter correspondingly to the reproduced plurality of menu domains or the reproduced another menu domain.

According to the information reproduction method of the present invention, the reproducing process reproduces the content domain form the content space, with the aid of a controller, a decoder, a demultiplexer, an optical pickup, and the like, in accordance with the operation in which a remote control or the like is used by a user. Alternatively, the reproducing process reproduces the plurality of menu domains, such as the title menu, or the another menu domain, such as the disc menu, from the system space, in accordance with the operation in which a remote control or the like is used by a user. By the user operation corresponding to the reproduction of the menu domains as described above, the system parameter corresponding to the menu domain is externally set through the setting device, such as a remote control and an operation panel. Then, the controlling device controls the reproducing device to reproduce the content domain or domains, in accordance with the system parameter externally set.

Therefore, it is possible to reproduce the information relatively efficiently onto the above-described information record medium of the present invention (including its various aspects).

Incidentally, the information reproduction method of the present invention can also adopts various aspects in response to various aspects of the above-described information record medium of the present invention.

An information record reproduction apparatus of the present invention is provided with: a first recording device for recording a plurality of content domains into a content space which occupies one area in a recording area of an information record medium, each content domain being constructed from a series of content information; a second recording device for recording a plurality of menu domains corresponding to the plurality of content domains into a system space which occupies a different area from the content space in the recording area, each menu domain being constructed from menu information as for the content information, the second recording device recording another menu domain into the system space, in addition to the plurality of menu domains, the another menu domain being constructed from menu information as for whole of the plurality of content domains or as for whole of the information record medium; a reproducing device for reproducing the content domain from the content space and reproducing the plurality of menu domains or the another menu domain from the system space; a setting device capable of externally setting a system parameter correspondingly to the reproduced plurality of menu domains or the reproduced another menu domain; and a controlling device for controlling the reproducing device to reproduce the content domain or domains, in accordance with the system parameter externally set by the setting device.

According to the information record reproduction apparatus of the present invention, it has both the information record apparatus and the information reproduction apparatus of the present invention described above, so that it is possible to record and reproduce the information relatively efficiently onto the above-described information record medium of the present invention (including its various aspects).

Incidentally, the information record reproduction apparatus of the present invention can also adopts various aspects in response to various aspects of the above-described information record medium of the present invention.

An information record reproduction method of the present invention is provided with: a first recording process of recording a plurality of content domains into a content space which occupies one area in a recording area of an information record medium, each content domain being constructed from a series of content information; a second recording process of recording a plurality of menu domains corresponding to the plurality of content domains into a system space which occupies a different area from the content space in the recording area, each menu domain being constructed from menu information as for the content information, the second recording process recording another menu domain into the system space, in addition to the plurality of menu domains, the another menu domain being constructed from menu information as for whole of the plurality of content domains or as for whole of the information record medium; a reproducing process of reproducing the content domain from the content space and reproducing the plurality of menu domains or the another menu domain from the system space; and a controlling process of controlling the reproducing process to reproduce the content domain, in accordance with a system parameter externally set by the setting device capable of externally setting the system parameter correspondingly to the reproduced plurality of menu domains or the reproduced another menu domain.

According to the information record reproduction method of the present invention, it has both the information record method and the information reproduction method of the present invention described above, so that it is possible to record and reproduce the information relatively efficiently onto the above-described information record medium of the present invention (including its various aspects).

Incidentally, the information record reproduction method of the present invention can also adopts various aspects in response to various aspects of the above-described information record medium of the present invention.

A computer program for controlling record of the present invention is a computer program for controlling record which controls a computer provided in the above-described information record apparatus of the present invention (including its various aspects) and which causes the computer to function as at least one portion of the first recording device and the second recording device.

According to the computer program for controlling record of the present invention, the above described information record apparatus of the present invention can be relatively easily realized as a computer reads and executes the computer program from a program storage device, such as a ROM (Read Only Memory), a CD-ROM (Compact Disc-Read Only Memory), a DVD-ROM (DVD Read Only Memory), and a hard disk, or as it executes the computer program after downloading the program through a communication device.

Incidentally, the computer program for controlling record of the present invention can also adopt various aspects in response to various aspects of the above-described information record medium of the present invention.

A computer program for controlling reproduction of the present invention is a computer program for controlling reproduction which controls a computer provided in the above-described information reproduction apparatus of the present invention (including its various aspects) and which causes the computer to function as at least one portion of the reproducing device, the setting device, and the controlling device.

According to the computer program for controlling reproduction of the present invention, the above described information reproduction apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, the computer program for controlling reproduction of the present invention can also adopt various aspects in response to various aspects of the above-described information record medium of the present invention.

A computer program for controlling record and reproduction of the present invention is a computer program for controlling record and reproduction which controls a computer provided in the above-described information record reproduction apparatus or the present invention (including its various aspects) and which causes the computer to function as at least one portion of the first recording device, the second recording device, the reproducing device, the setting device, and the controlling device.

According to the computer program for controlling record and reproduction of the present invention, the above described information record reproduction apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, the computer program for controlling record and reproduction of the present invention can also adopts various aspects in response to various aspects of the above-described information record medium of the present invention.

A data structure including a control signal of the present invention is provided with: a content space in which a plurality of content domains are recorded and which occupies one area in a recording area of the information record medium, each content domain being constructed from a series of content information; and a system space in which a plurality of menu domains corresponding to the plurality of content domains are recorded and which occupies a different area from the content space in the recording area, each menu domain being constructed from menu information as for the content information, another menu domain being recorded in the system space, in addition to the plurality of menu domains, the another menu domain being constructed from menu information as for whole of the plurality of content domains or as for whole of the information record medium.

According to the data structure including a control signal of the present invention, as in the case of the above-described information record medium of the present invention, in reproducing the information on a DVD player or the like, it is possible to perform the reproduction transition between the menu domain which is constructed from the menu information as for the whole of the information record medium, such as the disc menu about the entire DVD, and the menu domain which is constructed from the title menu effective for each title, easily and quickly.

Incidentally, the data structure including a control signal of the present invention can also adopts various aspects in response to various aspects of the above-described information record medium of the present invention.

The above object of the present invention can be also achieved by a computer program product for controlling record, in a computer-readable medium, for tangibly embodying a program of instructions executable by a computer provided in the above-described information record apparatus of the present invention (including its various aspects), to make the computer function as at least one portion of the first recording device and the second recording device.

The above object of the present invention can be also achieved by a computer program product for controlling reproduction, in a computer-readable medium, for tangibly embodying a program of instructions executable by a computer provided in the above-described information reproduction apparatus of the present invention (including its various aspects), to make the computer function as at least one portion of the reproducing device, the setting device, and the controlling device.

The above object of the present invention can be also achieved by a computer program product for controlling record and reproduction, in a computer-readable medium, for tangibly embodying a program of instructions executable by a computer provided in the above-described information record reproduction apparatus of the present invention (including its various aspects), to make the computer function as at least one portion of the first recording device, the second recording device, the reproducing device, the setting device, and the controlling device.

According to the computer program products for controlling record, reproduction, and record and reproduction of the present invention, at least one portion of the first recording device, the second recording device, the reproducing device, the setting device, and the controlling device of the present invention described above can be embodied relatively readily, by loading the computer program product from a record medium for storing the computer program product, such as a ROM, a CD-ROM, a DVD-ROM, a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as at least one portion of the first recording device, the second recording device, the reproducing device, the setting device, and the controlling device.

These functions and other advantages of the present invention will be apparent from the following description of embodiments.

### BRIEF DESCRIPTION OF DRAWINGS

FIG. 1 is a diagram showing a basic structure of an optical disc as being one embodiment of an information record medium of the present invention, the upper part being a schematic plan view of the optical disc having a plurality of areas, the corresponding bottom part being a schematic diagram of structures of the areas in the radial direction;

FIG. 2 is a schematic diagram of a conventional program stream of MPEG 2 (FIG. 2(a)), a schematic diagram of a transport stream of the MPEG 2 used in the embodiment (FIG. 2(b)); and a schematic diagram of a program stream of the MPEG 2 used in the embodiment (FIG. 2(c));

FIG. 3 is a schematic diagram showing a data structure recorded on the optical disc in the embodiment;

FIG. 4 is a schematic diagram showing details of the data structure in each title shown in FIG. 3;

FIG. 5 is a schematic diagram showing details of the data structure in each play list set shown in FIG. 3;

FIG. 6 is a schematic diagram showing details of the data structure in each play list set shown in FIG. 3;

FIG. 7 is a schematic diagram showing details of the data structure in each Item shown in FIG. 6;

FIG. 8 is a schematic diagram showing a logical structure of the data in each title element shown in FIG. 4;

FIG. 9 is a schematic diagram showing a logical structure of the data in each title element shown in FIG. 4 if each play list set is constructed from one play list in the embodiment;

FIG. 10 is a schematic diagram showing details of the data structure in each object shown in FIG. 3;

FIG. 11 is a schematic diagram showing that an elementary stream for a program #1 at an upper level and an elementary stream for a program #2 at a middle level are multiplexed, constituting a transport stream for these two programs, with the horizontal axis as a time axis;

FIG. 12 is a schematic diagram showing the image of TS packets multiplexed in one transport stream, as a packet alignment along time, in the embodiment;

FIG. 13 is a schematic diagram showing the logical structure of data on the optical disc in the embodiment, focusing on development from a logical hierarchy to an object hierarchy or an entity hierarchy;

FIG. 14 is a block diagram showing an information record/reproduction apparatus related to the embodiment of the present invention;

FIG. 15 is a flow chart showing a record operation (part 1) of the information record/reproduction apparatus in the embodiment;

FIG. 16 is a flow chart showing a record operation (part 2) of the information record/reproduction apparatus in the embodiment;

FIG. 17 is a flow chart showing a record operation (part 3) of the information record/reproduction apparatus in the embodiment;

FIG. 18 is a flow chart showing a record operation (part 4) of the information record/reproduction apparatus in the embodiment;

FIG. 19 is a flow chart showing a reproduction operation of the information record/reproduction apparatus in the embodiment;

FIG. 20 are conceptual diagrams showing one specific example of: a data structure of SP control information for controlling sub picture data (FIG. 20(a)); and a SP data structure including SP data as being still-picture data, which mainly constitutes the sub-picture data (FIG. 20(b));

FIG. 21 are conceptual diagrams showing three types of sub-picture structures, constructed from the SP control information and the SP data structure shown in FIG. 20;

FIG. 22 is a schematic diagram showing a relationship among a SPD stream and a plurality of SCP streams, with respect to a reproduction time axis;

FIG. 23 is a conceptual diagram showing the data structures of a system space and a content space in the embodiment;

FIG. 24 is a conceptual diagram showing the data structures of a system space and a content space in a comparison example;

FIG. 25 is a conceptual diagram showing one specific example of the data structure of title information in the embodiment;

FIG. 26 is a conceptual diagram showing one specific example of the data structures of system parameters (SPRM), set in an information record/reproduction apparatus 500 in the embodiment;

FIG. 27 is a conceptual diagram showing one example of specific set values of respective system parameters shown in FIG. 26;

FIG. 28 is a conceptual diagram showing one specific example of the data structure of resume information for the system space (SRSMI), set in the information record/reproduction apparatus in the embodiment;

FIG. 29 is a conceptual diagram showing one specific example of the data structure of resume information for the content space (TRSMI) set in the information record/reproduction apparatus in the embodiment;

FIG. 30 is a conceptual diagram showing a specific display example of a disc menu and its state being changed by menu selection;

FIG. 31 is a conceptual diagram showing a specific display example in one title menu and its state being changed by menu selection;

FIG. 32 is a conceptual diagram showing a specific display example in another title menu and its state being changed by menu selection;

FIG. 33 is a flowchart showing an operational flow in a reproduction transition between the menu domains, in an information record reproduction apparatus, in the embodiment;

FIG. 34 is a flowchart showing an operational flow in a reproduction transition from the system space to the content space, in the information record reproduction apparatus, in the embodiment;

FIG. 35 is a flowchart showing an operational flow in a reproduction transition from the content space to the system space, in the information record reproduction apparatus, in the embodiment;

FIG. 36 is a flowchart showing an operational flow in a reproduction transition between the content domains, in the information record reproduction apparatus, in the embodiment;

FIG. 37 is a schematic diagram conceptually showing an entire access flow in reproducing, in relation to the logical structure of the optical disc in the embodiment; and

FIG. 38 is a diagram schematically showing one specific example of the data structures of an AU table constructed in an object information file and an ES map table related to the AU table in one specific example in the embodiment.

### BEST MODE FOR CARRYING OUT THE INVENTION

(Information Record Medium)

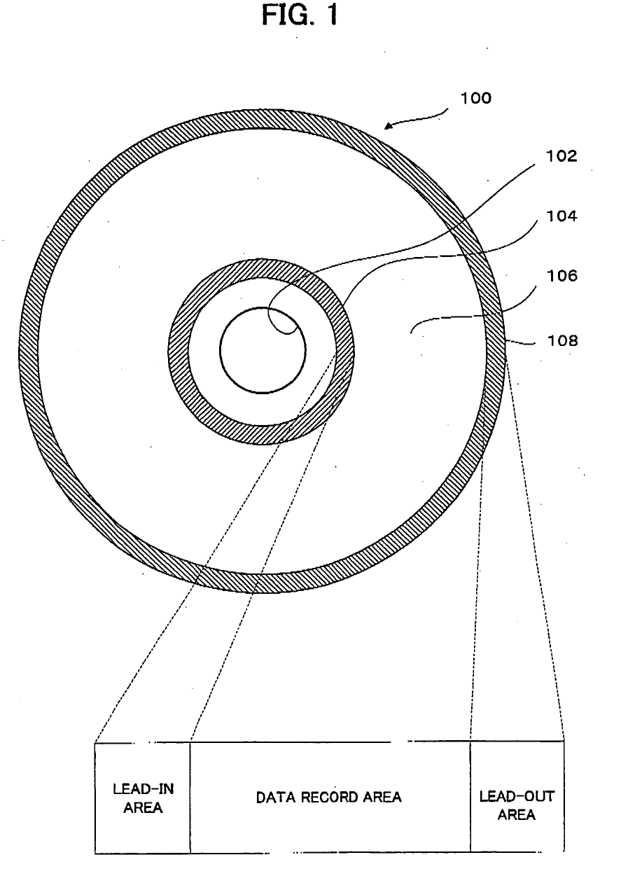

The embodiment of an information record medium of the present invention will be explained with reference to FIG. 1 to FIG. 13. In this embodiment, the information record medium of the present invention is applied to an optical disc of a type capable of recording (writing) and reproducing (reading).

Firstly, the basic structure of the optical disc in the embodiment will be explained with reference to FIG. 1. The upper part of FIG. 1 is a schematic plan view of the optical disc structure having a plurality of areas, in relation to which the bottom part is a schematic diagram of structures of the areas in the radial direction.

As shown in FIG. 1, an optical disc 100 is recordable in various recoding methods, such as a magnet-optical method and a phase transition method, onto which it is possible to record (write) information many times or only once. It is provided with a lead-in area 104, a data record area 106, and a lead-out area 108 on a record surface on the disc main body, which is about 12 cm in diameter, as is the DVD, with a center hole 102 as the center, in the direction from the inner circumference to the outer circumference. In each area, groove tracks and land tracks are alternately placed spirally or coaxially with the center hole 102 as the center, for example. These groove tracks may be wobbled, and pre-pits may be formed on either or both of the tracks. Incidentally, the present invention is not specially limited to an optical disc having these three areas.

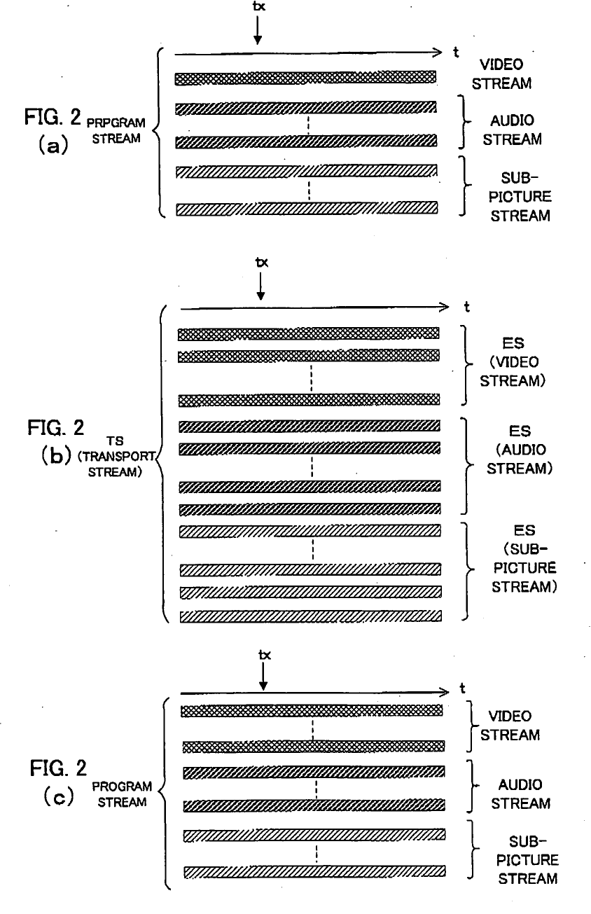

Secondly, the structures of a transport stream (TS) and a program stream (PS) recorded on the optical disc of the present invention will be explained with reference to FIG. 2. FIG. 2(a) schematically shows the structure of a program stream of MPEG 2 in a conventional DVD, as a comparison. FIG. 2(b) schematically shows the structure of a transport stream (TS) of the MPEG 2. FIG. 2(c) schematically shows the structure of the programs stream of the MPEG 2 in the present invention.

In FIG. 2(a), one program stream, recorded on the conventional DVD, includes (i) only one video stream for video data as being the video information, and further (ii) at most 8 audio streams for audio data as being the audio information, and also (iii) at most 32 sub picture streams for sub picture data as being the sub picture information, along a time axis t. Namely, the video data multiplexed at an arbitrary time point tx is related only to the one video stream. For example, a plurality of video streams corresponding to a plurality of TV shows or movies cannot be included in the program stream at the same time. In order to multiplex the TV show and the like accompanying pictures and transmit or record them, at least one video stream is required for each TV show and the like, so that the program stream format of the DVD in which only one video stream exists cannot allow the plurality of TV shows and the like to be transmitted or recorded after multiplexing them.

In FIG. 2(b), one transport stream (TS), recorded on the optical disc 100 of the present invention, includes (i) a plurality of video streams, as an elementary stream (ES) for the video data as being the video information, and further (ii) a plurality of audio streams, as an elementary stream (ES) for the audio data as being the audio information, and also (iii) a plurality of sub picture streams, as an elementary stream (ES) for the sub picture data as being the sub picture information. Namely, the video data multiplexed at an arbitrary time point tx is related to the plurality of video streams. For example, the plurality of video streams corresponding to a plurality of TV shows or movies can be included in the transport stream at the same time. As described above, the transport stream format in which there are the plurality of video streams can allow the plurality of TV shows and the like to be transmitted or recorded after multiplexing them. However, digital broadcasting that employs an existing transport stream does not transmit the sub picture stream.

In FIG. 2(c), one program stream (PS), recorded on the optical disc 100 of the present invention, includes (i) a plurality of video streams for the video data as being the video information, and further (ii) a plurality of audio streams for the audio data as being the audio information, and also (iii) a plurality of sub picture streams for the sub picture data as being the sub picture information. Namely, the video data multiplexed at an arbitrary time point tx is related to the plurality of video streams. For example, the plurality of video streams corresponding to a plurality of TV shows or movies can be included in the program stream at the same time.

Incidentally, in FIG. 2(a) to FIG. 2(c), the video stream, the audio stream, and the sub picture stream are arranged in this order from up to down for explanatory convenience; however, this order is not intended to correspond to an order of multiplexing them by a unit of packet, as described later, or the like. In the transport stream, one combination, which is one video stream, two audio streams, and two sub picture streams, conceptually corresponds to one show, for example.

The optical disc 100 in the embodiment described above is constructed to multiplex-and-record thereon the transport stream (TS) as shown in FIG. 2(b), i.e., to simultaneously record thereon the plurality of shows or programs. Moreover, it is constructed to multiplex-and-record the program stream (PS) as shown in FIG. 2(c) on the same optical disc 100, in addition to or in place of such a transport stream.

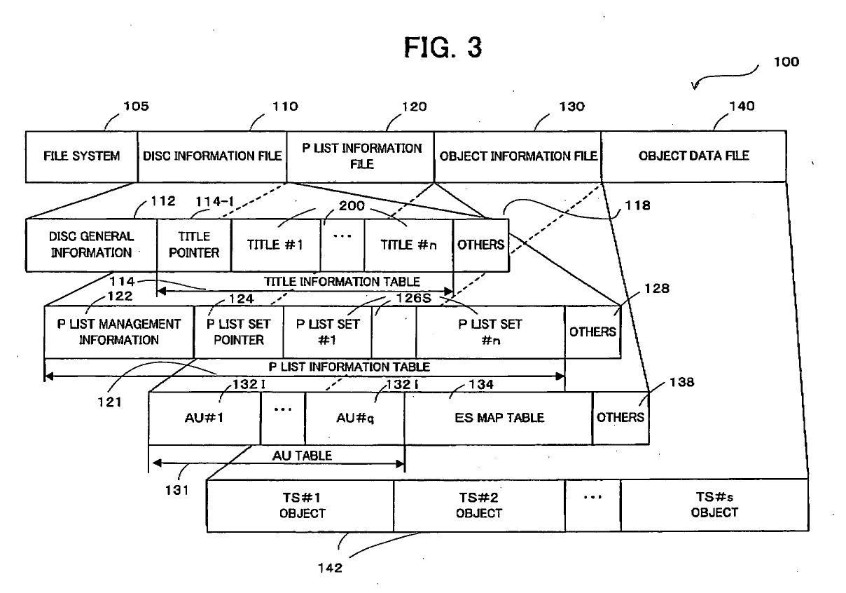

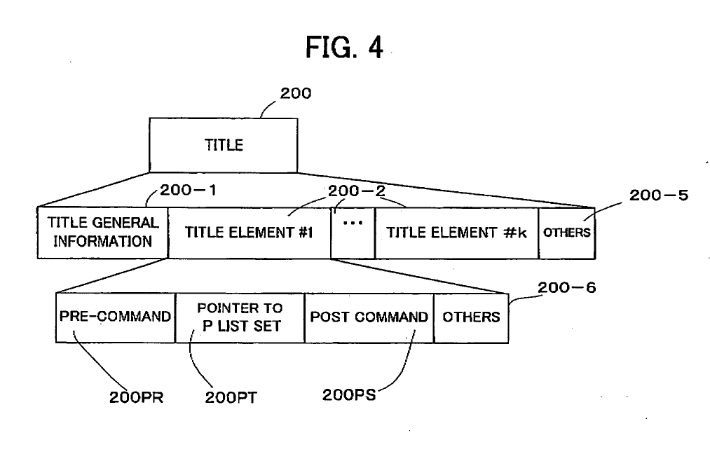

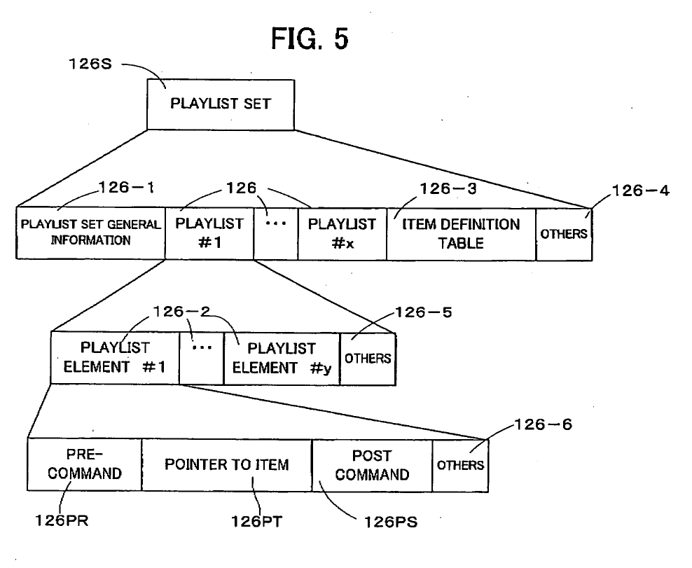

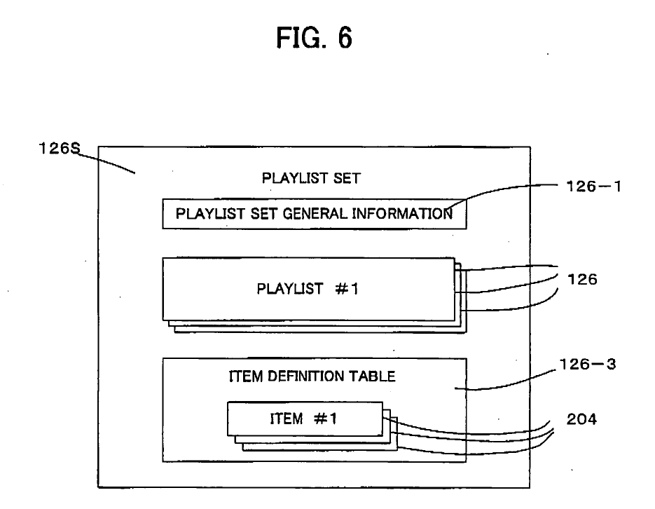

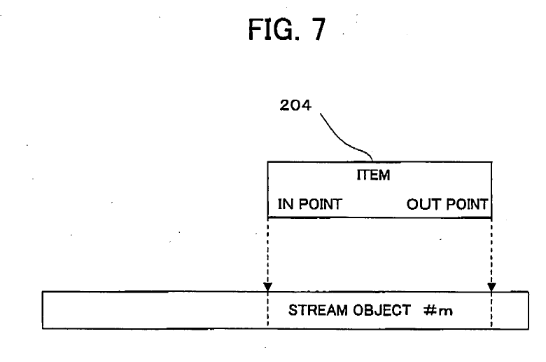

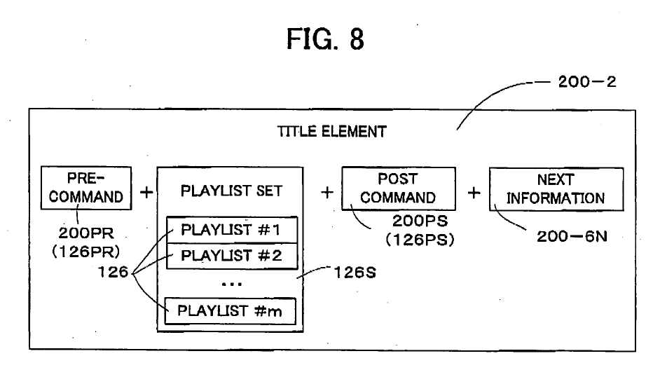

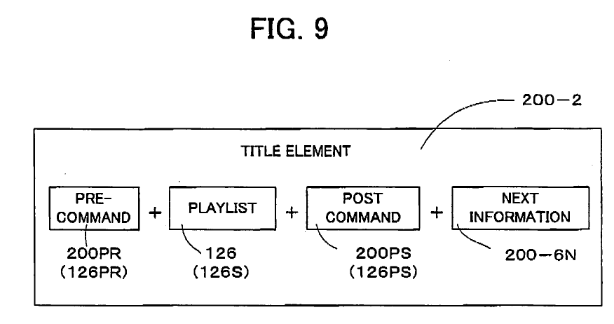

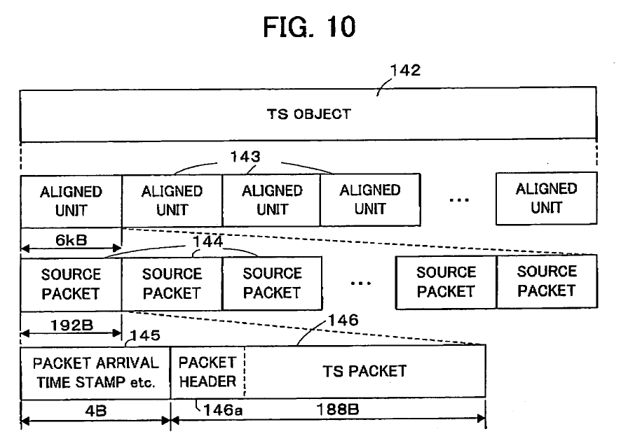

Next, a data structure recorded on the optical disc 100 will be explained with reference to FIG. 3 and FIG. 10. FIG. 3 schematically shows a data structure recorded on the optical disc 100. FIG. 4 schematically shows details of the data structure in each title shown in FIG. 3. FIG. 5 and FIG. 6 individually show details of the data structure in each play list set shown in FIG. 3. FIG. 7 schematically shows details of the data structure in each Item shown in FIG. 6. FIG. 8 schematically shows a logical structure of the data in each title element shown in FIG. 4. FIG. 9 schematically shows a logical structure of the data in each title element shown in FIG. 4 if each play list set is constructed from one play list. FIG. 10 schematically shows details of the data structure in each object shown in FIG. 3.

In the explanation below, the “title” is a reproduction unit by which a plurality of “play lists” is sequentially executed, and is a logically large grouped unit, such as one movie and one TV show. The “play list set” is a bundle of “play lists”. For example, it is a bundle of play lists for reproducing the plurality of content information which has a mutually changeable specific relationship, in angle reproduction and parental reproduction. Alternatively, it is a bundle of play lists for reproducing the content information related to a plurality of shows which is broadcasted at the same time zone and recorded together. Alternatively, it is a bundle of play lists for reproducing various content information, which is prepared for each required function, such as a video reproduction function (video performance) and an audio reproduction function (audio performance) required in an information reproducing system, for example, such as high vision compatibility, resolution of a display, surround speaker compatibility, speaker arrangement, and the like, regarding the same title. The “play list” is information for storing therein information required for the reproduction of an “object”, and is provided with a plurality of “Items”, each of which stores information about the reproduction range of the object to access the object. The “object” is the entity information of contents constituting the transport stream of the MPEG 2 described above.

In FIG. 3, the optical disc 100 is provided with the following four files, as a logical structure: a disc information file 110, a play (P) list information file 120, an object information file 130, and an object data file 140. It is further provided with a file system 105 to manage those files. Incidentally, FIG. 3 does not directly show the physical data alignment on the optical disc 100, but it is possible to record such that the arrangement order shown in FIG. 3 corresponds to the arrangement order shown in FIG. 1. Namely, it is possible to record the file system 105 or the like, into the lead-in area 104, and then into the data record area 106. Further, it is also possible to record the object data file 140 or the like, into the data record area 106. Even if the lead-in area 104 and/or the lead-out area 108 shown in FIG. 1 do no exist, the file structure shown in FIG. 3 can be constructed.

The disc information file 110 is a file for storing comprehensive information about the whole optical disc 100, and it stores disc comprehensive information 112, a title information table 114, and other information 118. The disc comprehensive information 112 stores the total number of titles and the like in the optical disc 100, for example. The title information table 114 includes a title pointer 114-1 and a plurality of titles 200 (titles #1 to #m) whose identification number or record address are indicated by the title pointer 114-1. In each title 200, each title type (e.g. a sequential reproduction type, a branch type, and the like) and a play (P) list number, which constitutes each title, are recorded as logical information.

More specifically, as shown in FIG. 4, each title 200 includes: title comprehensive information 200-1; a plurality of title elements 200-2; and other information 200-5. Moreover, the title element 200-2 is provided with: a pre command 200PR; a pointer 200PT to the play list set; a post command 200PS; and other information 200-6.

Here, the pointer 200PT, one example of the first pointer information of the present invention, indicates the identification number of a play list set 126S, which is stored in the play list information file 120 and which corresponds to the content information to be reproduced on the basis of the title element 200-2 including the pointer 200PT. Incidentally, the pointer 200PT may be information for indicating the record position of the play list set 126S corresponding to the content information to be reproduced on the basis of the title element 200-2. The pre command 200PR, one example of the first pre command of the present invention, indicates a command to be executed before the reproduction of the content information in which a reproduction sequence is defined by one play list set 126S which is specified by the pointer 200PT. The post command 200PS, one example of the first post command of the present invention, indicates a command to be executed after the reproduction of the content information in which a reproduction sequence is defined by the one play list set. The other information 200-5, included in the title element 200-2, includes next information for specifying a title element associated with next reproduction, in the reproduction of the title element.

Therefore, upon the reproduction of the information record medium by an information reproduction apparatus, as described later, the desired content information can be reproduced as the title element 200-2, by accessing the play list set 126S in accordance with the pointer 200PT, and by controlling such that one play list corresponding to a desired show or the like is selected from among a plurality of play lists 126 included in the play list set 126S. Moreover, by reproducing one title element 200-2 or sequentially reproducing such title elements 200-2, one title 200 can be reproduced. Moreover, in accordance with the pre commend 200PR, it is possible to execute the command to be executed before the reproduction of the content information in which a reproduction sequence is defined by one play list set 126S which is specified by the pointer 200PT. Furthermore, in accordance with the post commend 200PS, it is possible to execute the command to be executed after the reproduction of the content information in which a reproduction sequence is defined by one play list set 126S which is specified by the pointer 200PT. The post command PS is, for example, a command for instructing the branching of the content information, a command for selecting a next title, and the like. In addition, in accordance with the next information included in the other information 200-5, it is possible to reproduce the next title element 200-2 of the reproducing title element 200-2.

Again in FIG. 3, the play list information file 120 stores a play (P) list information table 121, which indicates the logical construction of each play list, and this is separated into play (P) list comprehensive information 122, a play (P) list pointer 124, a plurality of play (P) lists 126 (P lists #1 to #n), and other information 128. This play list information table 121 stores the logical information of each play list 126 in the order of the play list number. In other words, the storing order of each play list 126 is the play list number. Moreover, it is also possible to refer to the same play list 126 from a plurality of titles 200 at the above described title information table 114. Namely, even if a title #q and a title #r use the same play list #p, it is possible to construct such that the play list #p in the play list information table 121 is pointed at the title information table 114.

As shown in FIG. 5, the play list set 126S includes: play list set comprehensive information 126-1; a plurality of play lists 126 (play lists #1 to #x); an Item definition table 126-3; and other information 126-4. Each play list 126 includes: a plurality of play list elements 126-2 (play list elements #1 to #y); and other information 126-5. Moreover, each play list element 126-2 is provided with: a pre command 126PR; a pointer 126PT to an Item; a post command 126PS; and other information 126-6.

Here, the pointer 126PT, one example of the second pointer information of the present invention, indicates the identification number of the Item, which corresponds to the content information to be reproduced on the basis of the play list element 126-2 including the pointer 126PT. Incidentally, the pointer 126PT may be the record position of the Item defined by the Item definition table 126-3.

As illustrated in FIG. 6, in the play list set 126S, a plurality of Items 204 is defined in the Item definition table 126-3. These are shared by the plurality of play lists 126. Moreover, as the play list set comprehensive information 126-1, there are described User Interface information (UI), such as the name and reproduction time length of each play list 126 included in the play list set 126S, address information with respect to each Item definition table 126-3, and the like.

Again in FIG. 5, the pre command 126PR, one example of the second pre command of the present invention, indicates a command to be executed before the reproduction of one Item 204 which is specified by the pointer 126PT. The post command 126PS, one example of the second post command of the present invention, indicates a command to be executed after the reproduction of the one Item 204. The other information 126-6, included in the play list element 126-2, includes next information for specifying a play list element associated with next reproduction, in the reproduction of the play list element.

As illustrated in FIG. 7, the Item 204 is a smallest display unit. In the Item 204, “IN point information” for indicating the start address of the object, and “OUT point information” for indicating the end address of the object are written. Incidentally, these “IN point information” and “OUT point information” may individually indicate addresses directly, or indirectly with a time length or time point on the reproduction time axis. In FIG. 7, if a plurality of ES (Elementary Stream) is multiplexed with respect to the object indicated with a “stream object #m”, a combination of special ES or a special ES are specified, in the specification of the Item 204.

As illustrated in FIG. 8, the title element 200-2 is logically provided with: the pre command 200PR or 126PR; the play list set 126S, selected by the pointer 200PT; the post command 200PS or post command 126PS; and the next information 200-6N. Therefore, a process of selecting the play list 126 from among the play list set 126S is performed in accordance with some conditions which can be reproduced in a system or the like, such as video resolution, for example.

However, as illustrated in FIG. 9, if the play list set specified by the pointer 200PT is a single play list, i.e., if the play list set 126S shown in FIG. 3 is replaced by a single play list 126, the title element 200-2 may be logically provided with: the pre command 200PR or 126PR; the play list 126 reproduced in the reproduction; the post command 200PS or post command 126PS; and the next information 200-6N. In this case, regardless of the conditions which can be reproduced in a system or the like, if the play list set is specified for the reproduction, the reproduction process of the single play list 126 is performed.

Again in FIG. 3, the object information file 130 stores various attribute information about the storage position in the object data file 140 for each Item constructed in each play list 126 (i.e. a logical address that is a reproduction object) and about the reproduction of the Item. Especially, in this embodiment, the object information file 130 stores an AU (Associate Unit) table 131 including a plurality of AU information 132I (AU #1 to AU #q), as described later in detail, an ES (Elementary Stream) map table 134, and other information 138.

The object data file 140 stores a plurality of TS objects 142 (TS #1 object to TS #s object) for each transport streams (TS). Namely, it stores a plurality of entity data of the contents to be actually reproduced.

Incidentally, the four types of files explained with reference to FIG. 3 may be stored with each of them being separated into a plurality of files, and all of them may be managed or administered by the file system 105. For example, the object data file 140 can be separated into a plurality of data files, such as an object data file #1, an object data file #2, . . . and the like.

As shown in FIG. 10, the TS object 142 shown in FIG. 3, which is a logically reproducible unit, is divided into a plurality of aligned units 143, each of which has 6 kB data amount, for example. The head of the aligned units 143 corresponds to (or is “aligned” with) the head of the TS object 142. Each aligned unit 143 is further segmentized into a plurality of source packets 144, each of which has 192 B data amount. The source packet 144 is a physically reproducible unit, and by using this unit, i.e. by a unit of packet, at least the video data, the audio data, and the sub picture data are multiplexed among the data on the optical disc 100. The other information may be also multiplexed in this manner. Each source packet 144 includes: control information 145, which has 4 B data amount, for controlling the reproduction of a packet arrival time stamp indicating a reproduction start time point of the TS (transport stream) packet on a reproduction time axis etc.; and a TS packet 146, which has 188B data amount. The TS packet 146 (which is also referred to as a “TS packet payload”) has a packet header 146a at the head portion thereof. The video data is packetized to be a “video packet”, the audio data is packetized to be an “audio packet”, the sub picture data is packetized to be a “sub picture packet”, or the other data is packetized.

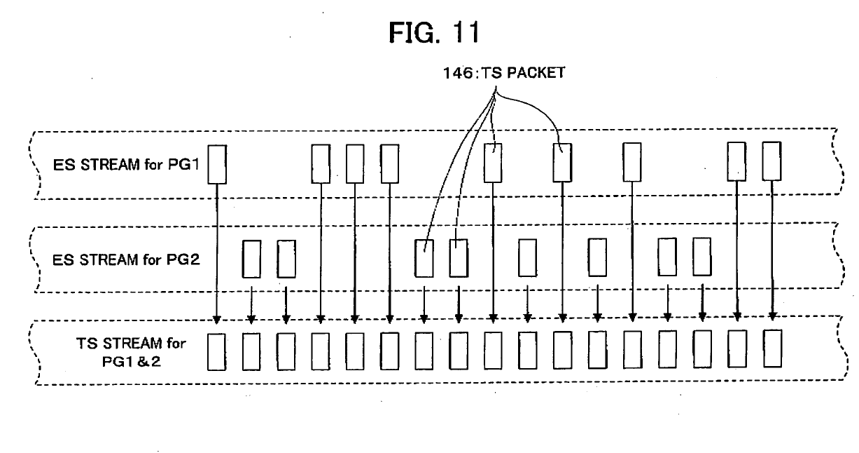

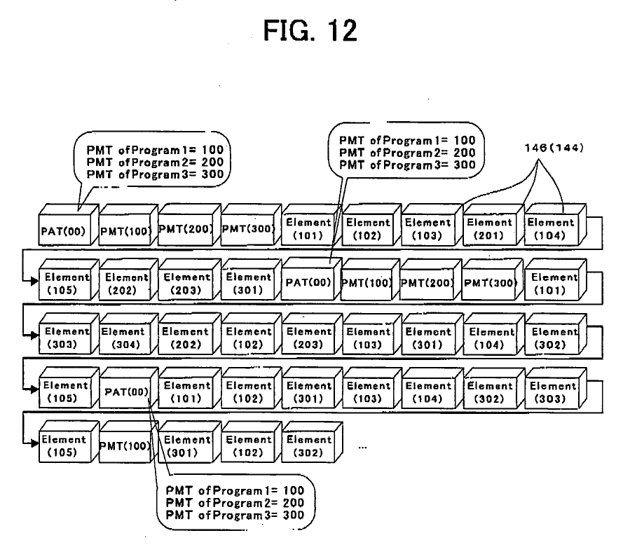

Next, with reference to FIG. 11 and FIG. 12, it will be explained that the video data, the audio data, the sub picture data, and the like, which are in the transport stream format as shown in FIG. 2(b), are multiplexed and recorded onto the optical disc 100 by the TS packet 146 shown in FIG. 4. FIG. 11 schematically shows that an elementary stream (ES) for a program #1 (PG 1) at the upper level in the figure and an elementary stream (ES) for a program #2 (PG 2) at the middle level in the figure are multiplexed, constituting a transport stream (TS) for these two programs (PG 1 & PG 2) at the lower level in the figure, with the horizontal axis as a time axis. FIG. 12 schematically shows the image of TS packets multiplexed in one transport stream (TS) as a packet alignment along time.

As shown in FIG. 11, the TS packets 146 with the video data for the program #1 packetized, are discretely arranged with respect to the time axis (horizontal axis) in the elementary stream for the program #1 (the upper one), for example. The TS packets 146 with the video data for the program #2 packetized, are discretely arranged with respect to the time axis (horizontal axis) in the elementary stream for the program #2 (the middle one), for example. Then, these TS packets 146 are multiplexed, constituting the transport stream (the lower one) for those two programs. Incidentally, this is omitted in FIG. 11 for explanatory convenience, but in fact, the elementary stream, provided with the TS packets in which the audio data is packetized, and the sub picture stream, provided with the TS packets in which the sub picture data is packetized, may be multiplexed as the elementary stream for the program #1 in the same manner, as shown in FIG. 2(b). Moreover, in addition to these, the elementary stream, provided with the TS packets in which the audio data is packetized, and the sub picture stream, provided with the TS packets in which the sub picture data is packetized, may be multiplexed as the elementary stream for the program #2 in the same manner.

As shown in FIG. 12, in this embodiment, one TS stream is constructed from many TS packets 146 multiplexed as described above. Then, the many TS packets 146 in this multiplexed form obtain the information 145, such as the packet arrival time stamp, and are multiplexed-and-recorded on the optical disc 100. Incidentally, “Element (i0j)” is used in FIG. 12 for the TS packet 146 comprising data which constitutes the program #i (i=1, 2, 3), with j (j=1, 2, . . . ) as a number indicating the order for each stream which constitutes the program. This (i0j) is a packet ID, which is the identification number of the TS packet 146 for each elementary stream. A specific value is given to this packet ID between the plurality of TS packets 146 multiplexed at the same time point so that the plurality of TS packets 146 can be mutually distinguished even if they are multiplexed at the same time point.

In FIG. 12, a PAT (Program Associate Table) and a PMT (Program Map Table) are also packetized by a unit of the TS packet 146 and are multiplexed. Among them, the PAT stores a table for indicating a plurality of PMT packet IDs. Especially, with regard to the PAT, the MPEG 2 standard defines the addition of (000), as shown in FIG. 12, as a predetermined packet ID. Namely, it is constructed such that the TS packet 146 in which the PAT is packetized is detected as the TS packet 146 with its packet ID (000), from among many packets multiplexed at the same time point. The PMT stores a table for indicating the packet ID for each elementary stream constituting each program with respect to one or a plurality of programs. To the PMT, an arbitrary packet ID may be added, but the packet ID of the PMT is indicated by the PAT with the packet ID being detectable as (000), as described above. Therefore, the TS packets 146 in each of which the PMT is packetized (i.e. the TS packets 146 with the packet IDs (100), (200), and (300) added in FIG. 12) are detected by virtue of the PAT, from among many packets multiplexed at the same time point.

In the case where the transport stream is digital-transmitted as shown in FIG. 12, a tuner can pick up the packets corresponding to the desired elementary stream, from among the multiplexed packets, by referring to the PAT and the PMT as constructed above, and demodulate them.

In this embodiment, the TS packet 146 stored in the TS object 142 shown in FIG. 10 includes these PAT and PMT packets. Namely, when the transport stream shown in FIG. 12 is transmitted, it can be recorded onto the optical disc 100 as it is, which is a great advantage.

Moreover, in this embodiment, the PAT and PMT as recorded above are not referred to upon the reproduction of the optical disc 100. Instead, by referring to the AU table 131 and the ES map table 134, as shown in FIG. 3 and as described later in detail, more effective reproduction is allowed, and complicate multi-vision reproduction and the like can be also treated with. On that account, in this embodiment, the corresponding relationship between the elementary stream and the packet, which are obtained by referring to the PAT and the PMT upon demodulating and recording, is stored in the object information file 130 in the form of the AU table 131 and the ES map table 134 without packetizing nor multiplexing.

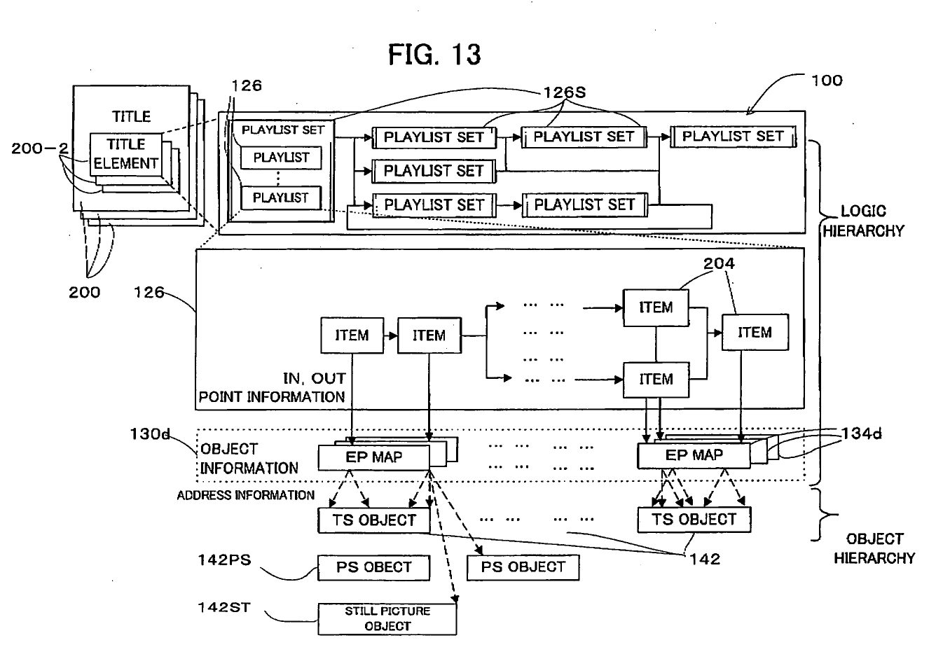

Next, the logical construction of the data on the optical disc 100 will be explained with reference to FIG. 13. FIG. 13 schematically shows the logical construction of the data on the optical disc 100, focusing on the development of a logical hierarchy to an object hierarchy or an entity hierarchy.

In FIG. 13, one or a plurality of titles 200, each of which is a logically large unit, such as one movie or one TV show, is recorded on the optical disc 100. Each title 200 includes one or a plurality of title elements 200-2. Each title element 200-2 is logically constructed from a plurality of play list sets 126S. In each title element 200-2, the plurality of play list sets 126S may have a sequential structure or a branch structure.

Incidentally, in the case of a simple logical construction, one title element 200 is constructed from one play list set 126S. Moreover, one play list set 126S is constructed from one play list 126. Moreover, one play list set 126S can be referred to from the plurality of title elements 200-2, or the plurality of titles 200.

Each play list 126 is logically constructed from a plurality of Items (i.e., the play items) 204. In each play list 126, the plurality of Items 204 may have the sequential structure or the branch structure. Moreover, one Item 204 can be referred to from the plurality of play lists 126. The reproduction range of the TS object 142 is logically specified by the above described IN point information and OUT point information written in the Item 204. Then, by referring to object information 130d with respect to the logically specified reproduction range, the reproduction range of the TS object 142 is physically specified via the file system in the end. Here, the object information 130d includes various information to reproduce the TS object 142, such as the attribute information of the TS object 142 and ES address information 134d required for a data search in the TS object 142 (incidentally, the ES map table 134 shown in FIG. 3 includes a plurality of such ES address information 134d).

Upon the reproduction of the TS object 142 by an information record/reproduction apparatus, which will be described later, a physical address to be reproduced in the TS object 142 is obtained from the Item 204 and the object information 130d, and the desired elementary stream is reproduced.

Incidentally, an Entry Point (EP) map which is shown in the object information 130d in FIG. 13 and which includes a plurality of ES address information 134d indicates herein an object information table in which both the AU table 131 and the ES map table 134 are summarized

In this embodiment, as described above, the association between the logical hierarchy and the object hierarchy of the reproduction sequence is made by the IN point information and the OUT point information described in the Item 204, and by the ES address information 134d described in the ES map table 134 (refer to FIG. 3) of the object information 130d, which enables the elementary stream to be reproduced.

As described above in detail, in the embodiment, the multiplexing and recording is performed on the optical disc 100 by a unit of the TS packet 146, and because of this, it is possible to multiplex-and-record onto the optical disc 100 the transport stream including many elementary streams as shown in FIG. 2(b). According to this embodiment, if digital broadcasting is recorded onto the optical disc 100, a plurality of shows or programs can be recorded at the same time within the limit of the record rate. Here, it employs a method of multiplexing the plurality of shows or programs and recording them into one TS object 142. The embodiment of an information record/reproduction apparatus executable this kind of record processing will be explained hereinafter.

(Information Record/Reproduction Apparatus)

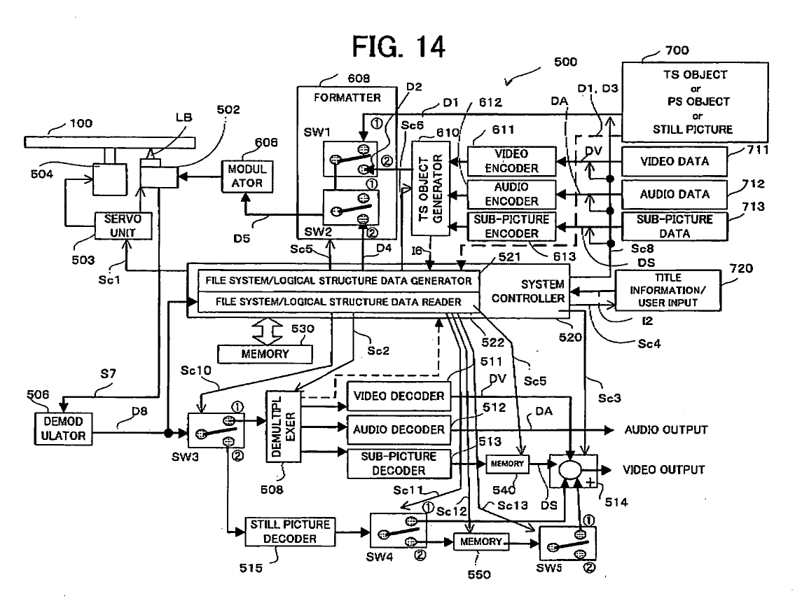

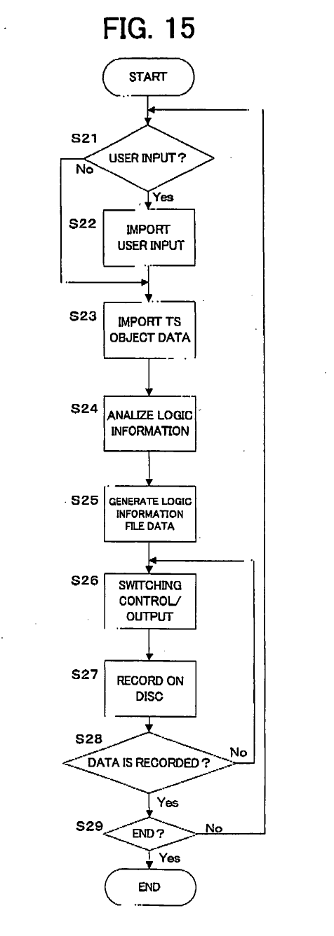

Next, the embodiment of the information record/reproduction apparatus of the present invention will be explained with reference to FIG. 14 to FIG. 19. FIG. 14 is a block diagram of the information record/reproduction apparatus, and FIG. 15 to FIG. 19 are flow charts showing its operation.

In FIG. 14, an information record/reproduction apparatus 500 is classified broadly into a reproduction system and a record system, can record information onto the optical disc 100 described above, and can reproduce the information recorded on this. In this embodiment, the information record/reproduction apparatus 500 is for recording and reproducing as described above, but it is possible to construct an embodiment of the record apparatus of the present invention from the record system part of the information record/reproduction apparatus 500. On the other hand, it is possible to construct an embodiment of the reproduction apparatus of the present invention from the reproduction system part of the information record/reproduction apparatus 500.

The information record/reproduction apparatus 500 is provided with: an optical pickup 502; a servo unit 503; a spindle motor 504; a demodulator 506; a demultiplexer 508; a video decoder 511; an audio decoder 512; a sub picture decoder 513; an adder 514; a still-picture decoder 515; a system controller 520; a memory 530; a memory 540; a memory 550; a modulator 606; a formatter 608; a TS object generator 610; a video encoder 611; an audio encoder 612; and a sub picture encoder 613. The system controller 520 is provided with a file system/logical structure data generator 521; and a file system/logical structure data interpret device 522. Moreover, the memory 530 and a user interface 720 for the user input of title information and the like are connected to the system controller 520.

Among these constitutional elements, the demodulator 506, the demultiplexer 508, the video decoder 511, the audio decoder 512, the sub picture decoder 513, the adder 514, the still-picture decoder 515; the memory 540; and the memory 550 constitute the reproduction system, mostly. On the other hand, among these constitutional elements, the modulator 606, the formatter 608, the TS object generator 610, the video encoder 611, the audio encoder 612, and the sub picture encoder 613 constitute the record system, mostly. The optical pickup 502, the servo unit 503, the spindle motor 504, the system controller 520, the memory 530, and the user interface 720 for the user input of the title information and the like are shared for both the reproduction system and the record system, mostly. Moreover, a TS object data source 700 (or a PS object data source 700, or a still-picture data source 700 for bit map data and JPEG data or the like), a video data source 711, an audio data source 712, and a sub picture source 713 are prepared for the record system. The file system/logical structure data generator 521, installed in the system controller 520, is mainly used in the record system, and the file system/logical structure data interpret device 522 is mainly used in the reproduction system.

The optical pickup 502 irradiates the optical disc 100 with a light beam LB, such as a laser beam, with a first power as a reading light upon reproducing, and with a second power as a writing light upon recording while modulating it. The servo unit 503 is controlled by a control signal Sc1 outputted from the system controller 520 upon reproducing and recording, and it performs a focus servo, a tracking servo, and the like at the optical pickup 502, as well as performing a spindle servo at the spindle motor 504. The spindle motor 504 is constructed to spin the optical disc 100 at a predetermined speed while receiving the spindle servo by the servo unit 503.

(i) Structure and Operation in Record System:

Next, the specific structure and operation of each constitutional element constituting the record system in the information record/reproduction apparatus 500 will be explained case by case, with reference to FIG. 14 to FIG. 18.

(i-1) In Using the Already Prepared TS Object:

This case will be explained with reference to FIG. 14 and FIG. 15.

In FIG. 14, the TS object data source 700 is provided with a record storage, such as a video tape and a memory, and it stores TS object data D1.

In FIG. 15, firstly, the information about each title (e.g. the structure content of the play list and the like) logically constructed on the optical disc 100 using the TS object data D1 is inputted from the user interface 720 to the system controller 520, as a user input 12 of the title information and the like. Then, the system controller 520 takes in the user input 12 of the title information and the like obtained from the user interface 720 (step S21: Yes and step S22). In this case, the user interface 720 is controlled by a control signal Sc4 from the system controller 520, and it can perform input processing according to the content to be recorded, such as selection through a title menu screen. Incidentally, if the user input has been already performed or the like (the step S21: No), this processing is omitted.

Then, the TS object data source 700 is controlled by a control signal Sc8 giving an instruction for reading out the data from the system controller 520, and outputs the TS object data D1. Then, the system controller 520 takes in the TS object data D1 from the TS object source 700 (step S23), and performs the analysis of the data array of the TS object data D1 (e.g. a record data length and the like), the analysis of each elementary stream structure (e.g. understanding of ES_PID (Elementary Stream•Packet Identification number) as described later), and the like, by virtue of a TS analysis function in the file system/logical structure data generator 521, for example, on the basis of the PAT, the PMT, and the like, packetized as well as the video data and the like as described above (step S24).

Then, the system controller 520 prepares the disc information file 110, the play list information file 120, the object information file 130, and the file system 105 (refer to FIG. 3), as logical information file data D4, by virtue of the file system/logical structure data generator 521, from the user input 12 of the taken-in title information and the like and from the analysis results of the data array of the TS object data D1 and each elementary stream (step S25). The memory 530 is used in preparing the logical information file data D4 described above.

Incidentally, such a variation that the data about the data array of the TS object data D1, the data about the construction information of each elementary stream, and the like are prepared in advance, is apparently and variously conceivable. Such a variation is also within the scope of the embodiment.

In FIG. 14, the formatter 608 is a device for performing a data array format to store onto the optical disc 100 the TS object data D1 and the logical information file data D4. More specifically, the formatter 608 is provided with a switch Sw1 and a switch Sw2 and is switching-controlled by a switch control signal Sc5 from the system controller 520. When formatting the TS object data D1, it connects the switch Sw1 to a \textcircled{1} side and the switch Sw2 to the \textcircled{1} side so as to output the TS object data D1 from the TS object data source 700. Incidentally, the transmission control of the TS object data D1 is performed by the control signal Sc8 from the system controller 520. On the other hand, when formatting the logical information file data D4, the formatter 608 is switching-controlled by the switch control signal Sc5 from the system controller 520, and connects the switch Sw2 to a \textcircled{2} side so as output the logical information file data D4.

In a step S26 in FIG. 15, (i) the logical information file data D4 from the file system/logical structure data generator 521 in the step S25 or (ii) the TS object data D1 from the TS object data source 700 is outputted through the formatter 608 by the switching-control by the formatter 608 as constructed above (step S26).

The selection output from the formatter 608 is transmitted to the modulator 606 as disc image data D5, is modulated by the modulator 606, and is recorded onto the optical disc 100 through the optical pickup 502 (step S27). The system controller 520 also executes the disc record control in this case.

Then, if both the logical information file data D4 generated in the step S25 and the corresponding TS object data D1 have not been completely recorded yet, the operational flow returns to the step S26, to continue the record (step S28: No). Incidentally, there is no preference in the record order of the logical information file data D4 and the corresponding TS object data D1.

On the other hand, if the both have been already recorded, it is judged whether or not the record on the optical disc 100 is supposed to be ended, on the basis of the presence or absence of an end command (step S29). If not supposed to be ended (the step S29: No), the operational flow returns to the step S21, to continue the record processing. On the other hand, if supposed to be ended (the step S29: Yes), a series of record processing ends.

As described above, the information record/reproduction apparatus 500 performs the record processing in using the already prepared TS object.

Incidentally, the example in FIG. 15 shows that the logical information file data D4 and the corresponding TS object data D2 are outputted in the step S26, after preparation of the logical information file data D4 in the step S25. However, it is also possible to execute the output of the TS object data D1 and/or the record of the TS object data D1 onto the optical disc 100 before the step S25, and after or in parallel with this recording, it is possible to generate and record the logical information file data D4.

In addition, the PS object data source or the still-picture data source may be used in place of the TS object data source 700. In this case, in place of the TS object data D1, the record processing for the TW object data D1 explained above is performed to PS object data or still-picture data, such as bit map data and JPEG data, in the same manner. In addition to or in place of the TS objects 142, the PS object data or the still-picture object data are stored into the object data file 140. Then, various logical information about the PS object data or the still-picture object data is generated under the control of the system controller 520, and stored in the disc information file 110, the play list information file 120, the object information file 130, and the like.

(i-2) In Receiving and Recording the Transport Stream on Air

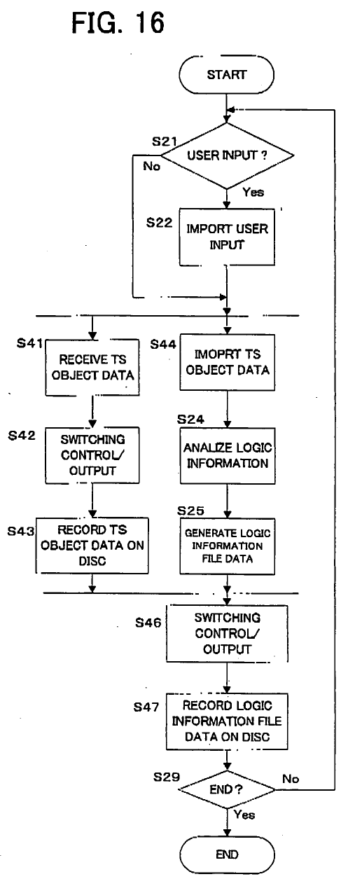

This case will be explained with reference to FIG. 14 and FIG. 16. Incidentally, in FIG. 16, the same steps as those in FIG. 15 have the same step reference numbers, and their explanation will be omitted as occasion demands.

Again, in this case, the similar processing is performed, as “in using the already prepared TS object” described above. Therefore, focusing on the differences from this case, the explanation will be done hereinafter.

In receiving and recording the transport stream on air, or the transport stream being broadcasted, the TS object data source 700 is provided with a receiver (set top box) for receiving the digital broadcast on air, for example, receives the TS object data D1, and transmits it to the formatter 608 in real time (step S41). At the same time, reception information D3 (i.e. information corresponding to the data transmitted through the receiver and the interface of the system controller 520) including program construction information and ES_PID information, as described later, which are deciphered upon receiving, is taken into the system controller 520 and is stored into the memory 530 (step S44).

In the meantime, the TS object data D1 outputted to the formatter 608 is outputted to the modulator 606 by the switching-control of the formatter 608 (step S42), and is recorded onto the optical disc 100 (step S43).

Along with these operations, using the program construction information and the ES_PID information included in the reception information D3, taken-in upon receiving and stored in the memory 530, the file system/logical structure data generator 521 prepares the logical information file data D4 (the step S24 and step S25). Then, after the record of a series of the TS object data D1 is completed, this logical information file data D4 is additionally recorded onto the optical disc 100 (step S46 and step S47). Incidentally, these step S24 and step S25 may be performed after the step S43.

Moreover, as the occasion demands (e.g. in editing one portion of the title, or the like), by adding the user input 12 of the title information and the like from the user interface 720 to the program construction information and the ES_PID information stored in the memory 530, it is possible to prepare the logical information file data D4 by the system controller 520 and additionally record this onto the optical disc 100.

As described above, the information record/reproduction apparatus 500 performs the record processing in receiving the transport stream on air and recording it in real time.

Incidentally, if all the reception data upon broadcasting is once stored into an archive apparatus, and then used as the TS object source 700, the same processing as “in using the already prepared TS object” will do.

(i-3) In Recording the Video Data, the Audio Data, and the Sub Picture Data

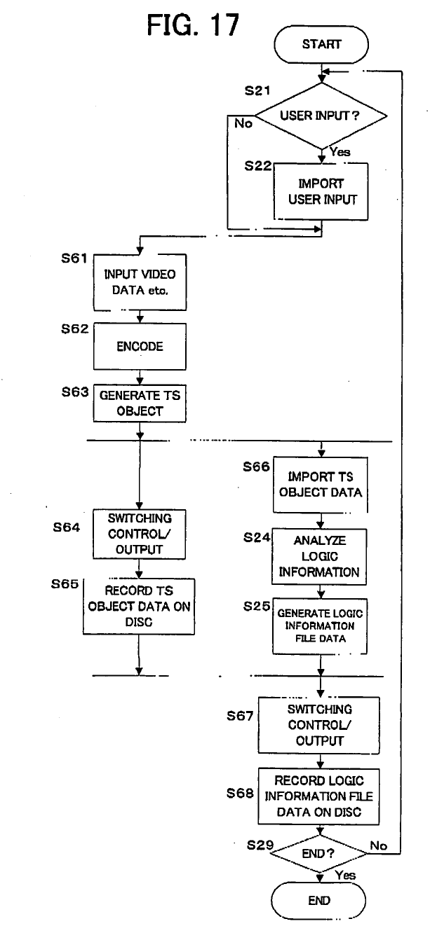

This case will be explained with reference to FIG. 14 and FIG. 17. Incidentally, in FIG. 17, the same steps as those in FIG. 15 have the same step reference numbers, and their explanation will be omitted as occasion demands.

In recording the video data, the audio data, and the sub picture data, which are individually prepared in advance, the video data source 711, the audio data source 712, and the sub picture data source 713 are individually provided with the record storage, such as a video tape and a memory, and store a video data DV, an audio data DA, and a sub picture data DS, respectively.

These data sources are controlled by the control signal Sc8, which gives an instruction for reading out the data from the system controller 520, and they transmit the video data DV, the audio data DA, and the sub picture data DS, to the video encoder 611, the audio encoder 612, and the sub picture encoder 613, respectively (step S61). Then, the video encoder 611, the audio encoder 612, and the sub picture encoder 613 execute a predetermined type of encode processing (step S62).

The TS object generator 610 is controlled by a control signal Sc6 from the system controller 520 and converts the data encoded in this manner to the TS object data constituting the transport stream (step S63). In this case, the data array information of each TS object data (e.g. a record data length and the like) and the construction information of each elementary stream (e.g. the ES_PID, as described later, and the like) are transmitted from the TS object generator 610 as information 16 to the system controller 520, and are stored into the memory 530 (step S66).

On the other hand, the TS object data generated by the TS object generator 610 is transmitted to the \textcircled{2} side of the switch Sw1 of the formatter 608. Namely, when formatting the TS object data from the TS object generator 610, the formatter 608 is switching-controlled by the switch control signal Sc5 from the system controller 520 to change the switch Sw1 to the \textcircled{1} side and the switch Sw2 to the \textcircled{1} side, thereby outputting the TS object data (step S64). Then, this TS object data is recorded onto the optical disc 100 through the modulator 606 (step S65).

Along with these operations, using the data array information of each TS object data and the construction information of each elementary stream taken into the memory 530 as the information 16, the file system/logical structure data generator 521 prepares the logical information file data D4 (the step S24 and the step S25). Then, after the record of a series of the TS object data D2 is completed, this is additionally recorded onto the optical disc 100 (step S67 and step S68). Incidentally, the step S24 and the step S25 may be processed after the step S65.

Moreover, as the occasion demands (e.g. in editing one portion of the title and the like), by adding the user input 12 of the title information and the like from the user interface 720 to these information stored in the memory 530, it is possible to prepare the logical information file data D4 by the file system/logical structure generator 521 and additionally record this onto the optical disc 100.

As described above, the information record/reproduction apparatus 500 performs the record processing in recording the video data, the audio data, and the sub picture data, which are individually prepared in advance.

Incidentally, this record processing is applicable even in recording an arbitrary content the user has.

(i-4) In Recording the Data by Authoring

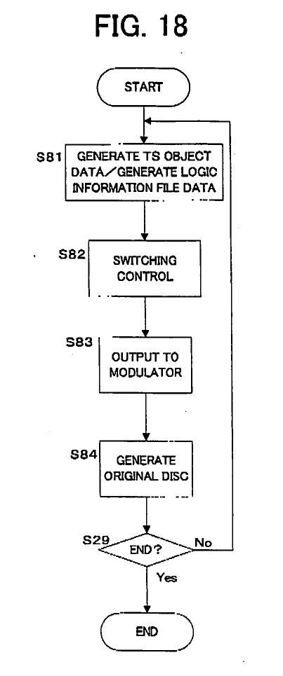

This case will be explained with reference to FIG. 8 and FIG. 18. Incidentally, in FIG. 18, the same steps as those in FIG. 15 have the same step reference numbers, and their explanation will be omitted as occasion demands.

In this case, by combining the above described three types of record processing in the three cases, an authoring system generates the TS object, the logical information file data, and the like in advance (step S81), and then completes the switching-control processing of performed at the formatter 608 (step S82). Then, the information obtained by this operation is transmitted to the modulator 606 equipped in front of and/or behind an original disc cutting machine, as the disc image data D5 (step S83), and this cutting machine prepares the original disc (step S84).

(ii) Structure and Operation in Reproduction System

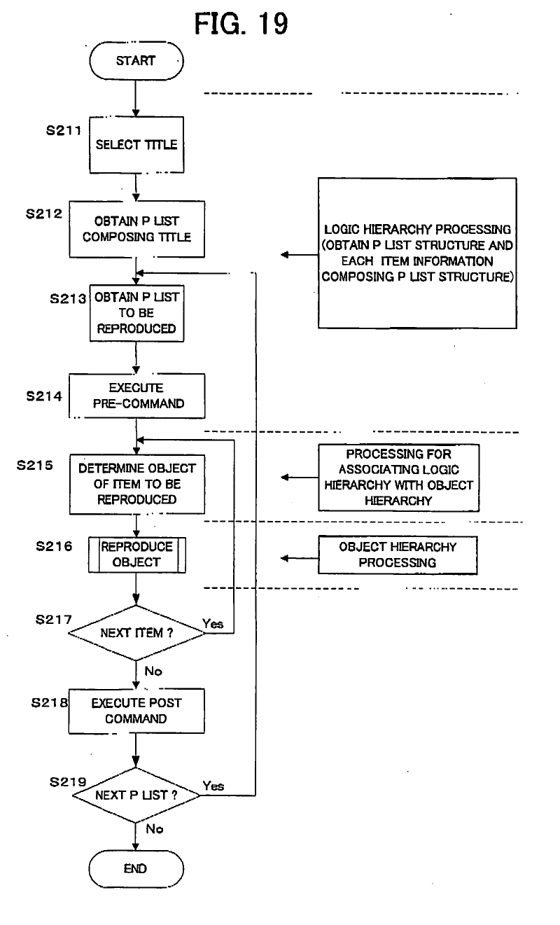

Next, the specific structure and operation of each constitutional element constituting the reproduction system in the information record/reproduction apparatus 500 will be explained with reference to FIG. 14 and FIG. 19.

In FIG. 14, the user interface 720 inputs the title to be reproduced from the optical disc 100, its reproduction condition, and the like, to the system controller as the user input 12 of the title information and the like. In this case, the user interface 720 is controlled by the control signal Sc4 from the system controller 520, and it can perform the input processing according to the content whose reproduction is desired, such as selection through a title menu screen.

Responding to this, the system controller 520 controls the disc reproduction with respect to the optical disc 100, and the optical pickup 502 transmits a reading signal S7 to the demodulator 506.

The demodulator 506 demodulates a recorded signal recorded on the optical disc 100 from this reading signal S7, and outputs it as demodulated data D8. The logical information file data (i.e. the file system 105, the disc information file 110, the P list information file 120, and the object information file 130, shown in FIG. 3) included in this demodulated data D8 as being a not-multiplexed information part is supplied to the system controller 520. On the basis of this logical information file data, the system controller 520 executes various reproduction control, such as determination processing of determining a reproduction address and controlling the optical pickup 502.

On the other hand, depending on whether the TS object data as being a multiplexed information part is included in the demodulation data D8 or the still-picture data is included, or both data is included, a switch Sw3 is controlled by a control signal Sc10 from the system controller 520, and switched to the demultiplexer 508 side as being the \textcircled{1} side, or to the still-picture decoder 515 side as being the \textcircled{2} side.

Then, as for the TS object data included in the demodulated data D8 as being a multiplexed information part, the demultiplxer 508 is controlled by a control signal Sc2 from the system controller 520 to demultiplex the TS object data. Here, the control signal Sc2 is transmitted so as to start demultiplexing when an access to a reproduction position address is completed by the reproduction control of the system controller 520.

The demultiplexer 508 transmits and supplies the video packet, the audio packet, and the sub picture packet, to the video decoder 511, the audio decoder 512, and the sub picture decoder 513, respectively. Then, the video data DV, the audio data DA, and the sub picture data DS are respectively decoded. At this time, the sub picture data DS is supplied to the adder 514 through the memory 540. The memory 540 is controlled by the control signal Sc5 from the system controller 520. The sub picture data DS is outputted from the memory 540, in predetermined timing or selectively, and is superimposed with the video data DS, if desired. Namely, as compared to the case where the sub picture data outputted from the sub picture decoder 513 is superimposed as it is, it is possible to control the timing of the superimposing, and the necessity or unnecessity of the superimposing. For example, it is possible to display or not to display subtitles by using the sub picture on the video, if needed, by the output control using the control signal Sc5. Alternatively, it is possible to display or not to display a menu screen using the sub picture.

Incidentally, the packets included in the transport stream, in each of which the PAT or the PMT is packetized as shown in FIG. 6, are individually included as a part of the demodulated data D8; however, they are discarded or abandoned at the demultiplexer 508.

The adder 514 is controlled by a control signal Sc3, which gives an instruction of the mixing from the system controller 520, and mixes or superimposes, in predetermined timing, the video data DV and the sub picture data DS, which are respectively decoded at the vide decoder 511 and the sub picture decoder 513. The result is outputted as a video output from the information record/reproduction apparatus 500 to a TV monitor, for example.

On the other hand, the audio data DA decoded at the audio decoder 512 is outputted as an audio output from the information record/reproduction apparatus 500 to an external speaker, for example.

In place of or in addition to the reproduction processing of the video data DV and the sub picture data DS as described above, if the still picture data is included in the demodulated data D8, the still picture data is supplied to the still picture decoder 515 through the switch SW 3 which is controlled by the control signal Sc 10 from the system controller 520. Then, the decoded still picture data, such as bit map data and JPEG data, is added to the adder 514 as it is, through a switch SW4 which is controlled by a control signal Sc 11 from the system controller 520. Alternatively, it is once accumulated in the memory 550 through the switch SW4. The memory 550 is controlled by a control signal Sc12 from the system controller 520. The still picture data is outputted from the memory 550, in predetermined timing or selectively, and supplied to the adder 514 through a switch SW5. This allows the superimposing between the still picture data and the video data DV or the sub picture data DS, if desired. Namely, as compared to the case where the still picture data outputted from the still picture decoder 515 is superimposed as it is, it is possible to control the timing of the superimposing, and the necessity or unnecessity of the superimposing. For example, it is possible to display or not to display a still picture, such as a menu screen and a window screen, or a still picture as a background picture, which use the sub picture data, onto the video or sub picture, if needed, by the output control using the control signal Sc12.

In addition, the still picture data may be separately outputted in a not illustrated route, through a switch SW5 which is controlled by a control signal Sc 13 from the system controller 520 to switch to the \textcircled{2} side. Alternatively, by switching to the \textcircled{2} side, no still picture data may be outputted from the switch SW5.

Here, the specific example of a reproduction processing routine by the system controller 520 will be explained with reference to a flowchart in FIG. 19.

In FIG. 19, it is assumed that as an initial condition, the recognition of the optical disc 100 in the reproduction system and the recognition of a volume structure and a file structure by the file system 105 (refer to FIG. 3) have been already completed by the system controller 520 and the file system/logical structure data interpret device 522 inside the system controller 520. Here, the operational flow after obtaining the total number of the titles from the disc comprehensive information 112 in the disc information file 110 and selecting one title 200 from among them will be explained.

Firstly, the selection of the title 200 is performed by the user interface 720 (step S211). In response to this, the system controller 520 obtains the information about the reproduction sequence from the reading result of the file system/logical structure data interpret device 522. Incidentally, in the selection of the title 200, a desired one of the plurality of title elements 200-2 (refer to FIG. 4) that constitutes the title 200, may be selected by an external input operation by a user using a remote control or the like. Alternatively, one title element 200-2 may be automatically selected in accordance with a system parameter or the like which is set on the information record/reproduction apparatus 500.

Then, the content of the plurality of play lists 126 that constitutes the play list set 126S corresponding to the selected title 200 (the title element 200-2) is obtained. At this time, as the processing of the logical hierarchy, the information about the structure of each play list 126 and the information about each of the Items 204 constituting the play list (refer to FIG. 5, FIG. 6, and FIG. 13) are obtained (step S212).

Then, from among the plurality of play lists 126 obtained in the step S212, the content of the play list 126 to be reproduced is obtained. Here, for example, the reproduction is started from the play list #1, and the content of the corresponding play list 126 is obtained (step S213). The content of the play list 126 is one or a plurality of play list elements 126-2 (refer to FIG. 5) or the like. In the acquisition process in the step S213, such play list elements 126-2 or the like are obtained.

Then, the pre command 126PR (refer to FIG. 5) included in this play list 126 is executed (step S214). Incidentally, it is possible to select one of the plurality of play lists 126 having a particular relationship, which constitute the play list sets 126S, by the pre command 126PR. Moreover, if the play list elements 126-2 constituting the play list 126 do not have the pre command 126PR, this processing is omitted.

Then, on the basis of the Item 204 (refer to FIG. 5 to FIG. 7) specified by the play list 126 which is obtained in the step S213, the TS object 142 to be reproduced (refer to FIG. 3 and FIG. 10) is determined (step S215). More specifically, on the basis of the Item 204, the object information file 130 (refer to FIG. 3) associated with the TS object 142 which is the reproduction object is obtained, and the stream number, address, and the like of the TS object 142 to be reproduced are specified.

Incidentally, in the embodiment, the AU (Associate Unit) information 1321 and PU (Presentation Unit) information 302I, which will be described later, are also obtained as the information stored in the object information file 130. These obtained information allows the association or correlation of the above-described logical hierarchy and the object hierarchy (refer to FIG. 13).

Then, the reproduction of the TS object 142 determined in the step S215 is actually started. Namely, on the basis of the processing of the logical hierarchy, the processing of the object hierarchy is started (step S216).

During the reproduction processing of the TS object 142, it is judged whether or not there is a next Item 204 constituting the play list 126 to be reproduced (step S217). As long as there is the next Item 204 (the step S217: Yes), the operational flow returns to the step S215, and the determination and reproduction processing of the above-described TS object 142 are repeated.

On the other hand, in the judgment in the step S217, if there is not any next Item 204 (the step S217: No), the post command 126PS (refer to FIG. 5) corresponding to the play list 126 in execution is executed (step S218). Incidentally, if the play list elements 126-2 constituting the play list 126 do not have the post command 126PS, this processing is omitted.

Then, it is judged whether or not there is a next play list 126 constituting the selected title 200 (step S219). If there is any (the step S219: Yes), the operational flow returns to the step S213, and the processing after the acquisition of the play list 126 to be reproduced is repeatedly performed.

On the other hand, in the judgment in the step S219, if there is not any next play list 126 (the step S219: No); namely, if the reproduction of all of the play lists 126 to be reproduced in response to the selection of the title 200 in the step S211 is completed, a series of reproduction processing is ended.

As explained above, the reproduction processing of the optical disc 100 by the information record/reproduction apparatus 500 in the embodiment is performed.

Particularly in the embodiment, in (i) Structure and Operation in Record System, explained above, if various content information is recorded, a content space described in detail later is logically constructed, and if various menu domains and first play domains are recorded, a system space is logically constructed, in the same manner.

Particularly in the embodiment, in (ii) Structure and Operation in Reproduction System, explained above, in selecting the title in the step S211 and in reproducing the object in the step S216, the reproduction transition between the menu domains in the system space, the reproduction transition between the content domains in the content space, the reproduction transition between the menu domain and the content domain extending over the system space and the content space, or the like are performed. These will be described in detail later.

(Selection Method of Play List in Play List Set)

In the embodiment, the play list 126 corresponding to the desired content information is selected, as occasion demands, from the play list set 126S which is included in the reproduced play list information file 120.

With respect to such selection of the play list, the pre command 200PR may be provided with a play list selection command group list in which a selection condition is described, for each play list 126, and the selection of the play list may be performed in accordance with the selection condition. It may be also performed in accordance with the attribute information appended to each play list 126 which is stored in the play list set 126S (e.g. information for indicating the attribute of the content information related to the play list, such as video resolution about a video function, distinction of progressive/interleave, a video codec, the number of audio channels, and an audio codec). Alternatively, it may be also performed in accordance with play list set control information, which is included in the title element 200-2, for storing the selection condition for each play list. By such selection, it is possible to select what corresponds to the desired content information, such as a desired show, a desired parental block, and a desired angle block. Alternatively, for example, it is possible to select such a play list that can be reproduced by the information reproduction system and that fully uses or maximizes the video reproduction function and the audio reproduction function owned by the information reproduction system.

(Structure and Control of Sub Picture Data)

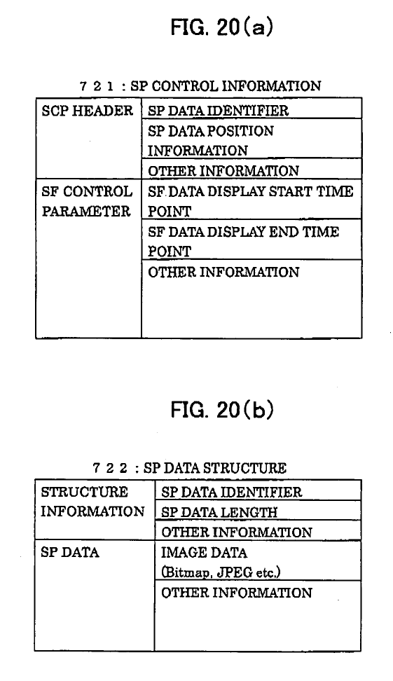

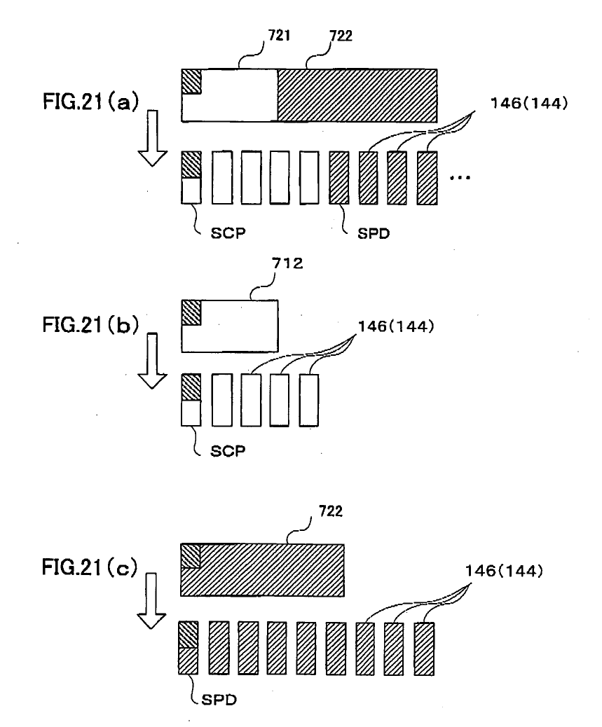

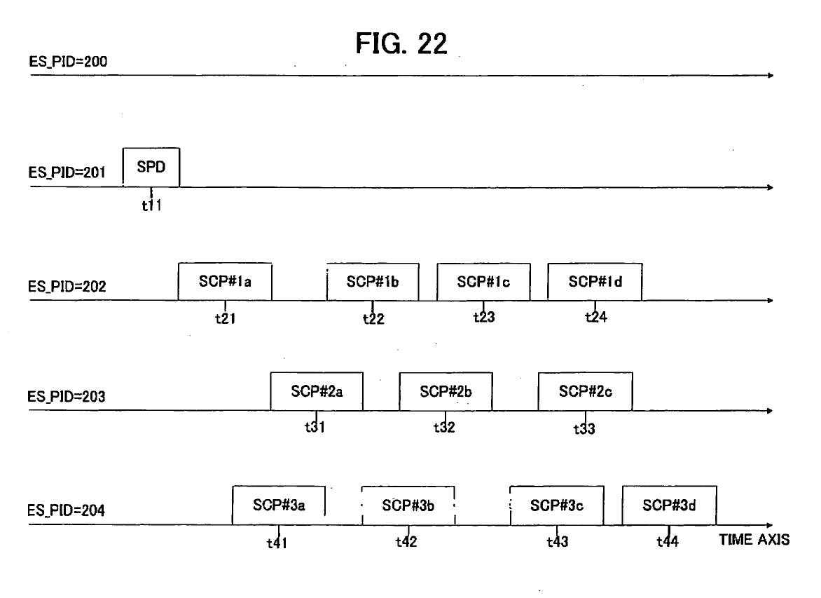

Next, with reference to FIG. 20 to FIG. 22, the structure and control of the sub picture data will be explained. FIG. 20 are conceptual diagrams showing one specific example of: a data structure of SP control information for controlling sub picture data (FIG. 20(a)); and a SP data structure including SP data as being still-picture data, which mainly constitutes the sub-picture data (FIG. 20(b)). FIG. 21 are conceptual diagrams showing three types of sub-picture structures, constructed from the SP control information and the SP data structure. FIG. 22 schematically shows a relationship between a SPD stream and a plurality of SCP streams, with respect to a reproduction time axis.

In the embodiment, in FIG. 14, the sub picture data decoded by the sub picture decoder 513 is temporarily stored in the memory 540 which functions as a buffer. Then, at least one of the SP data (Still Picture data) and the SP control information (Still Picture control data), which are included in the temporarily stored sub picture data, are controlled by the control signal Sc5 from the system controller 520, to be thereby read out. Then, by operating the SP control information onto the SP data, the display of a still picture is performed as part or all of the video output.

As shown in FIG. 20(a), SP control information 721 has a SCP header and a SF control parameter. The “SCP header” is provided with a SP data identifier for specifying the SP data which is regarded as a control object by the SP control information 721, information for indicating a record position of the SP data, and the like. The “SF control parameter” is a unit of sub frame (SF) which is an image portion cut out as at least one portion of images defined by the SP data, and is provided with various parameters for controlling the SP data. More specifically, it has parameters for indicating a display start time point and a display end time point of the SF data by using PTS (Presentation Time Stamp) or the like. Moreover, it has various parameters for indicating conditions, such as a display time length, a cut out range of the sub picture and its configuration in displaying, magnification and reduction in scale, and rotation.

As shown in FIG. 20(b), a SP data structure 722 has structure information and SP data (an entity of the still picture data). The “structure information” is provided with a SP data identifier, information about the length of the SP data, and the like. The “SP data” has image data or the like, in a bit map data format or in a JPEG format, which is run length encoded.

Thus, in the reproduction of the sub picture data, various reproduction control which uses the sub frame is performed on the basis of the SF control parameter shown in FIG. 20(a), by the unit of sub frame in which at least one portion of the SP data shown in FIG. 20(b) is cut out.

As shown in FIG. 21, the SP control information 721 and the SP data structure 722 are packetized into a plurality of TS packets 146 (refer to FIG. 10) and multiplexed. The TS packet 146 for storing therein the head portion of the SP control information 721 in the sub picture structure is referred to as a “SCP”, and the TS packet 146 for storing therein the head portion of the SP data structure 722 in the sub picture structure is referred to as a “SPD”.

As shown in FIG. 21(a), both the SP control information 721 including the SCP and the SP data structure 722 may be regarded as one sub picture structure and divided into the plurality of TS packets 146. As shown in FIG. 21(b), the SP control information 721 including the SCP may be regarded as one sub picture structure and divided into the plurality of TS packets 146. As shown in FIG. 21(c), the SP data structure 722 including the SPD may be regarded as one sub picture structure and divided into the plurality of TS packets 146.

In the embodiment, for example, with respect to the SP data in the SP data structure 722 recorded on a SPD stream, the SP control information recorded on a SCP stream different from the SPD stream is operated, to thereby perform the reproduction control of the still picture. In this case, there may be only one or a plurality of SCP streams which operates with respect to one SPD stream. Recording the two types of streams onto mutually different elementary streams allows efficient reproduction control. Moreover, operating a plurality of SP control information on a plurality of SCP streams, with respect to the SP data on one SPD stream, allows more efficient reproduction control.

More specifically, as shown in FIG. 22, at a time point t11 during reproduction of a video stream (Video 1) of “ES_PID=200”, the reading of the SP data (SPD1) on a SPD stream of “ES_PID=201” is started, and it is stored into the memory 540 of the information record/reproduction apparatus 500 (refer to FIG. 14). Then, the stored SP data is stored until a set end time point, for example, or is stored until the reading a next sub picture is started.

In FIG. 22, on a SCP stream (SCP1) of “ES_PID=202”, SCP#1a, SCP#1b, SCP#1c, and SCP#1d are provided in timing of a time point t21, a time point t22, a time point t23, and a time point t24, respectively. On a SCP stream (SCP2) of “ES_PID=203”, SCP#2a, SCP#2b, and SCP#2c are provided in timing of a time point t31, a time point t32, and a time point t33, respectively. On a SCP stream (SCP3) of “ES_PID=204”, SCP#3a, SCP#3b, SCP#3c, and SCP#3d are provided in timing of a time point t41, a time point t42, a time point t43, and a time point t44, respectively.

However, in addition to such reproduction control of the still picture, it is possible that with respect to the SP data in the sub picture data structure recorded on the sub picture stream, the SP control information in the sub picture structure recorded on the same stream is operated, to thereby perform the reproduction control of the still picture. Namely, both the SP control information 721 and the SP data structure 722 may be recorded into only one sub picture stream, to thereby operate the SP control information 721 to the SP data structure 722.

In any case, by sharing or using many times the SP data provided as the bit map data and JPEG data which have a large data amount, it is possible to save a limited recording capacity on the disc, which allows more efficient reproduction and display processing. In addition, in any case, it is possible to superimpose such a sub picture onto a moving picture or video which is based on the video data recorded in another video stream.

(Reproduction Transition Between Domains)

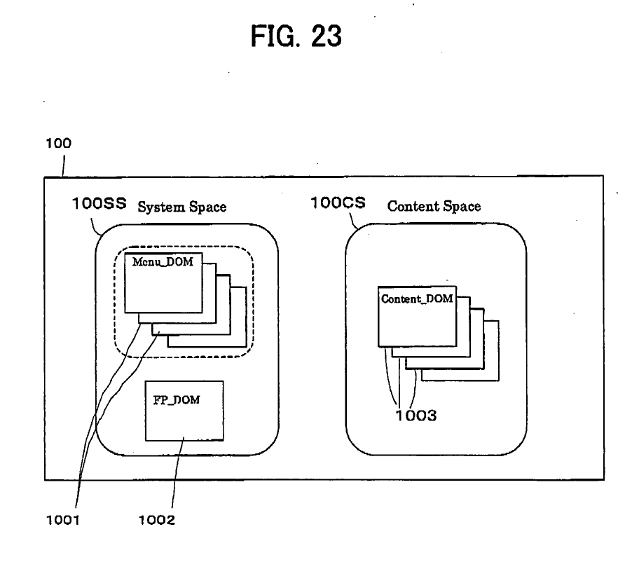

Next, with reference to FIG. 23 to FIG. 36, the reproduction transition between the domains in the reproduction of the optical disc 100 constructed in the above manner will be explained.

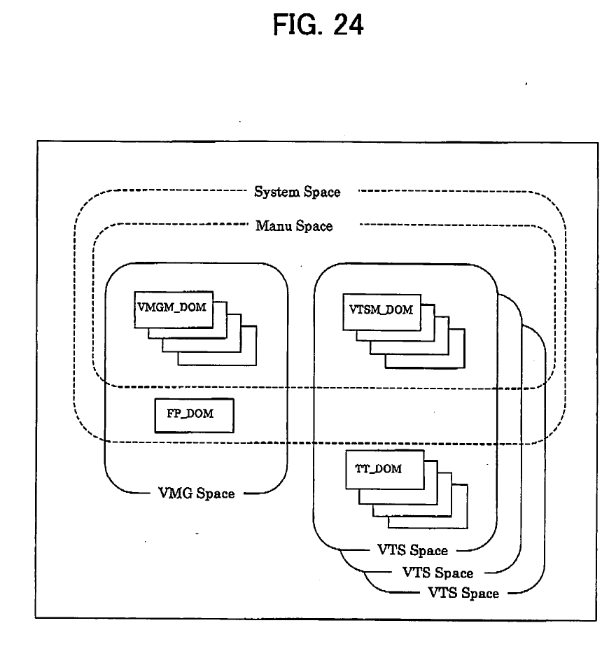

At first, with reference to FIG. 23 and FIG. 24, a system space and a content space constructed on the optical disc 100 in the embodiment will be explained. FIG. 23 is a conceptual diagram showing the data structures of the system space and the content space in the embodiment. FIG. 24 is a conceptual diagram showing the data structures of the system space and the content space in a comparison example.

In the embodiment, as shown in FIG. 23, a system space 100SS and a content space 100CS are logically constructed in a recording area on the optical disc 100. In the system space 100SS, a plurality of menu domains (Menu DOM) 1001 are recorded, each of which includes the menu information about the content information. In the content space 100CS, a plurality of content domains (Content DOM) 1003 are recorded, each of which is constructed from a series of content information.

The plurality of menu domains 1001 in the system space 100SS include at least one menu domain 1001 constructed from the menu information about all the plurality of content domains 1003 or the entire optical disc 100, in addition to the menu domain 1001 constructed from the menu information corresponding to the plurality of content domains 1003 in the content space 100CS. More specifically, the plurality of menu domains 1001 include the menu domain 1001 associated with the content domain 1003, such as the individual title 200, which is being reproduced; for example, there is listed a menu operation for changing audio and a video angle, and the like, during the reproduction of the content domain 1003 in the content space 100CS. Except this, the plurality of menu domains 1001 include the menu domain 1001 about the entire disc 100. It is, for example, the menu domain 1001 associated with a disc menu or the like which is the menu of all the titles 200 recorded on the optical disc 100. The menu domain 1001 about the whole, such as the disc menu as described above, is the menu domain associated with the whole of the information record medium; for example, there is listed a menu operation for performing the display of all the titles, audio selection and setting (e.g. speaker arrangement setting in an audio surround system), the change and setting of audio languages, the change and setting of subtitle languages, and the like, which is common to all the titles on the disc.

Moreover, in the embodiment, in the system space 100SS, a first play domain (FP_DOM) 1002 is recorded in addition to the plurality of menu domains 1001. The first play domain (FP_DOM) 1002 is a content domain for the first play, which is reproduced in the initial stage of the reproduction operation.

As shown in FIG. 24, in a recording area on an optical disc in the comparison example, the system space and the menu space are logically overlapped. Then, the video manager (VMG) space and a plurality of Video Title Set (VTS) spaces are further logically constructed and partially included in both the system space and the content space. In the video manager space, there are recorded a plurality of video manager menu domains (VMGM_DOM) and a first play domain (FP_DOM). On the other hand, in each of the Video Title Set spaces, there are recorded a plurality of video title set menu domains (VTSM_DOM) and a plurality of title set domain (TT_DOM). Each VTSM_DOM is constructed from the menu information for the individual content information constituting a title. Each TT_DOM is constructed from the content information constituting a title.

As opposed to the case of the comparison example in which the spaces are overlapped to each other as described above, in the case of the optical disc 100 in the embodiment as shown in FIG. 23, the content space 100CS in which the plurality of content domains 1003 are recorded, and the system space 1000SS in which the plurality of menu domains 1001 are recorded, occupy different areas in the recording area on the optical disc 100.

Therefore, in the reproduction of the optical disc 100, in order to reproduce the menu domain 1001 associated with the content domain 1003 which is being reproduced during the reproduction of the content domain 1003 in the content system 100CS, the reproduction transition may be performed from the content space 100CS to the system space 100SS, to thereby reproduce the corresponding menu domain 1001. Alternatively, even in order to reproduce the menu domain associated with the entire optical disc 100 which is being reproduced during the reproduction of the content domain 1003 as described above, the reproduction transition may be performed from the content space 100CS to the system space 100SS in the same manner, to thereby reproduce the corresponding menu domain 1001. Particularly, even in reproducing the menu domain 1001 associated with the entire optical disc 100 during the reproduction of the menu domain 1001 associated with the content domain 1003 which is being reproduced, it is enough if the reproduction transition is performed in the same system space 100SS.

As described above, according to the embodiment, in the reproduction of the optical disc 100 on the information record reproduction apparatus 500, it is possible to perform the reproduction transition between the content domains 1003 in the content space 100CS, the reproduction transition between the menu domains 1001 in the system space 100SS, and particularly, the reproduction transition between the menu domain 1001 associated with the individual content in the system space 100SS and the menu domain 1001 associated with the entire optical disc 100, quickly and easily.

Particularly, the quick and easy reproduction transition in the same system space 100SS can be performed between the menu domain 1001 for displaying the disc menu associated with the entire disc and the menu domain 1001 for displaying a title menu associated with the individual title.

In the case where the reproduction transition is performed in the same system space 100SS or the same content space 100CS in the embodiment as described above, with regard to the processing of the information record reproduction apparatus 500, such a processing load is reduced that is related to the elimination and discard or destruction of a system parameter described in detail later, the reading and setting of new control information and the like, as compared to the case of the DVD in the comparison example shown in FIG. 24. Thus, it is relatively easy to display any one of the menu domains 1001 in a condition that the content information which is being reproduced is temporarily stopped, perform the setting and change of the system parameter of the information record reproduction apparatus 500, and then restart (i.e. resume) the temporarily stopped content information.

In addition, in the embodiment, the first play domain 1002 is recorded in the system space 100SS. Thus, in the reproduction of the optical disc 100, a screen which shows general information, such as the producer or author, distribution company, and the like of the optical disc 100, is unconditionally reproduced at first, in response to the insertion of the optical disc 100 into the information record reproduction apparatus 500. Then, following this, the easy and quick reproduction transition can be performed with respect to the menu domain 1001 which is the disc menu or the like, and the menu domain 1001 which is the title menu or the like, recorded in the system space 100SS in the same manner.

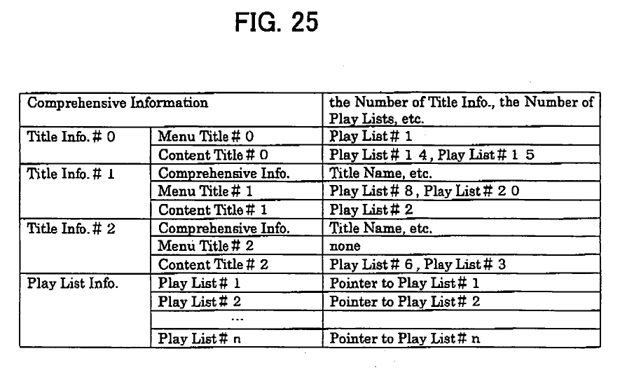

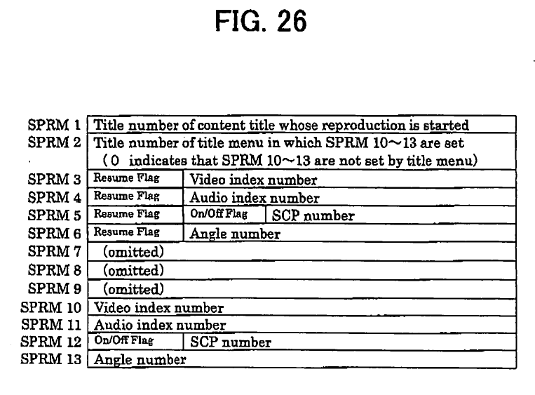

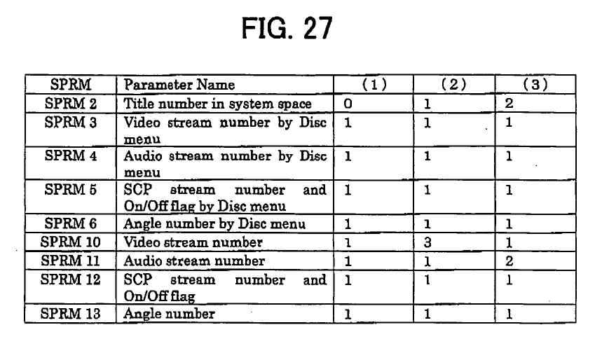

Next, with reference to FIG. 25 to FIG. 27, the titles reproduced by the content domains 1003 constituting the content space 100CS will be explained by giving a specific example. The system parameter (SPRM) used on the information record reproduction apparatus 500 in reproducing the title will be also explained. FIG. 25 is a conceptual diagram showing one specific example of the data structure of the title information. FIG. 26 is a conceptual diagram showing one specific example of the data structures of the system parameters (SPRM), set in the information record/reproduction apparatus 500. FIG. 27 is a conceptual diagram showing one example of specific set values of respective system parameters shown in FIG. 26.

As shown in FIG. 25, the title information for reproducing each title is distinguished by title numbers (#0, #1, . . . ). Each title information is provided with a menu title and a content title. Here, the menu title is a menu for setting audio selection, subtitle language section, and the like for the title, and is recorded in the menu domain 1001 shown in FIG. 23. Moreover, the content title is the content itself of a movie or the like, and is recorded in the content domain 1003 shown in FIG. 23. Each menu title and each content title have the same number as the title number of the corresponding title information. For example, the title #1 is provided with the title information #1 constructed from the menu title #1 and the content title #1.

In FIG. 25, for example, there are both the menu title #1 and the content title #1 with respect to the title #1. In the menu title #1, the content information to be reproduced as the menu is specified by the play lists #8 and #20. In the content title #1, the content information to be reproduced as the title is specified by the play list #2. Moreover, there is no menu title with respect to the title #2, but there is the content title #2. In the content title #2, the content information to be reproduced as the title is specified by the play lists #6 and #3.

In FIG. 25, the title #0 represents the disc menu as the menu title. The “disc menu” is a menu for displaying all the title names recorded on the optical disc 100 and setting the audio selection and the subtitle language selection common in all of the titles. With respect to the title in which the menu title is not recorded, the audio selection and the subtitle language selection and the like are set by the disc menu. Moreover, with respect to the title in which the menu title is recorded, the default of the audio selection and the subtitle language selection may be set by the disc menu. If there are menus about the same item in a content menu, a change may be applied to the default setting by the menus.

As shown in FIG. 26, in order to perform the menu reproduction and the content reproduction with respect to the plurality of titles illustrated in FIG. 25, a plurality of system parameters SPRM 1 to 13 are set in the information record reproduction apparatus 500 in the embodiment. Each of the system parameters SPRM 1 to 13 is 32 bits, for example.

Namely in FIG. 26, the title number of the content title whose reproduction is started is set in the system parameter SPRM 1. The title number of the title menu in setting the system parameters SPRM 10 to 13 is set in the system parameter SPRM 2. Incidentally, if this value is “0”, it means the system parameters SPRM 10 to 13 are not set by the title menu. For example, the initial value of the system parameter is set to “0”, which is set upon power-on, or the like.

A video index number is set in the system parameter SPRM 10. An audio index number is set in the system parameter SPRM 11. The On/Off flag of a sub-picture and a SCP number are set in the system parameter SPRM 12. These system parameters SPRM 10 to 13 are set in reproducing the title menu associated with the individual title.

If the system parameter SPRM 2 is not set, the set values of the system parameters SPRM 10 to 13 are effective, even if the reproduction transition about the menu domain is arbitrarily performed.

Particularly, in the embodiment, a resume flag in the top 1 bit and the video index number are set in the system parameter SRPM 3. A resume flag in the top 1 bit and the audio index number are set in the system parameter SRPM 4. A resume flag in the top 1 bit and the On/Off flag of a sub-picture and the SCP number are set in the system parameter SRPM 5. A resume flag in the top 1 bit and the angle number are set in the system parameter SRPM 6. These system parameters SPRM 3 to 6 are set by the disc menu, and regarded as the set values, common to all the titles. Moreover, the resume flags are appended to enable resume reproduction. Incidentally, if the system parameters SPRM 3 to 6 are set, the system parameters SPRM 10 to 13 are set to the same value, individually.

The system parameters SPRM 10 to 13 can be set from anything other than the menu title #0 and the content title #0 corresponding to the disc menu. If set from the menu title whose set value is different from that of the system parameter SRPM 2 (other than “0” which indicates the disc menu), the system parameters SPRM 10 to 13 are set after resetting in the system parameters SPRM 3 to 6.

The “ON/OFF flag” associated with these system parameters is a parameter for specifying whether the display of subtitles or the like by the sub-picture is performed (ON) or not performed (OFF). The “SCP number” is a parameter for specifying the number of the SCP in which the SP control information is stored in performing the display by the sub-picture. The “angle number” is a parameter for specifying an angle number in performing the angle reproduction. Moreover, the “resume flag” is a flag for indicating whether the disc menu is selected in order to perform the resume reproduction or not to perform the resume reproduction.

Incidentally, with respect to the judgment of whether or not to perform the resume reproduction, for example, if a stop button is pressed once in the remote control operation by a user, it may be judged that the resume reproduction is to be performed. If the stop button is pressed twice, it may be judged that the resume reproduction is not to be performed. Alternatively, the judgment may be performed by an operation button, which is mounted on a remote control and an operation panel, for specifying the resume reproduction.

In FIG. 27, as a specific example, set values when the system parameters SPRM 3 to 6 are set to “1” on the disc menu are shown in a column (1) of the table of FIG. 27. Then, set values when the video stream number of the title #1 is changed to #3 in the menu title #1 are shown in a column (2) of the table of FIG. 27. Moreover, shifting to the menu title #2, set values when the audio stream number is changed to #2 are shown in a column (3) of the table of FIG. 27.

As shown in FIG. 27, in individually setting the system parameters SPRM 10 to 13 or 3 to 6 on the title menus for different titles, it is possible to reset the system parameters once by using the set values of the disc menu, to thereby set the values for the titles. At this time, the information record reproduction apparatus 500 can easily recognize the effectiveness or ineffectiveness of the set values, by comparing the currently displayed title number with the system parameter SPRM 2, and can decide the subsequent operating conditions in accordance with the recognition.

Moreover, in transferring from the system space 100SS to the content space 100CS (e.g. in starting to watch an actual movie), if the system parameter SPRM 2 is set to “0”, i.e. in the case of the menu selection by the disc menu, or if the system parameter SPRM 2 is not the same as the title number of the movie whose reproduction will be started, the reproduction is started after the resetting of the system parameters SPRM 10 to 13 by using the system parameters SPRM 3 to 6.

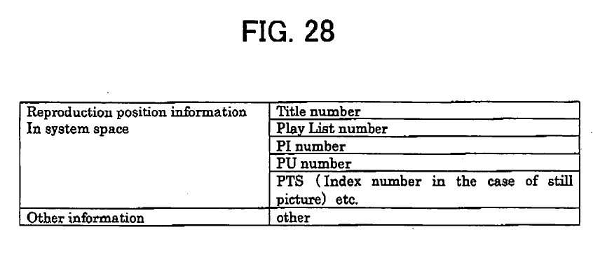

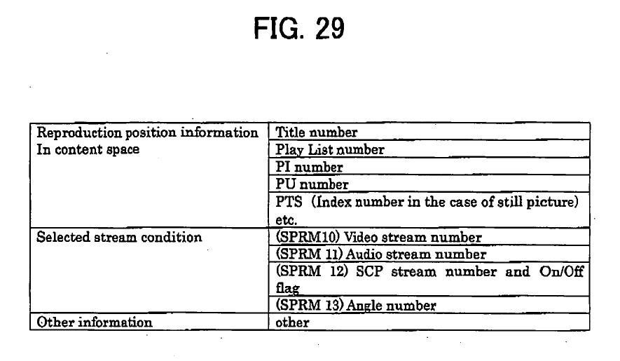

Next, with reference to FIG. 28 and FIG. 29 in addition to FIG. 26, the resume reproduction will be explained which is performed in the reproduction of the disc menu based on the system parameters SPRM 3 to 6. FIG. 28 is a conceptual diagram showing one specific example of the data structure of resume information for the system space (SRSMI), set in the information record/reproduction apparatus 500. FIG. 29 is a conceptual diagram showing one specific example of the data structure of resume information for the content space (TRSMI) set in the information record/reproduction apparatus 500.

The resume flags included in the system parameters 3 to 6 shown in FIG. 26 indicate that the system parameters are set in a resume condition by the disc menu. Here, the resume indicates that after the reproduction transition to the system space 100SS is performed to thereby display the menu, during the title reproduction associated with the content (moreover, usually, after a user selection operation is performed), the rest of the title associated with the content which is being reproduced immediately before the reproduction transition is reproduced. The resume information is control information for performing such resume reproduction. In the embodiment, two types of resume information are used, as occasion demands.

Namely, in the embodiment, the resume information for the system space SRSMI and the resume information for the content space TRSM are used, as occasion demands.

In FIG. 28, the resume information for the system space SRSMI has reproduction position information in the system space 100SS. This includes information about the title number, the play list number, PI information, PU information, PTS (e.g. the index number in the case of the still-picture) and the like, for example. Thus, if the resume reproduction is performed during the reproduction in the system space 100SS, the resume information SRSMI is set before the reproduction transition. Then, if the reproduction is restarted in accordance with the resume information SRSMI at the restart of the reproduction, the resume reproduction is performed. For example, during the reproduction of one title menu, the disc menu and other title menus can be reproduced, and then, the resume reproduction can be performed in the original title menu.

In FIG. 29, the resume information for the content space TRSMI has reproduction position information in the content space 100CS. This includes information about the title number, the play list number, PI information, PU information, PTS (e.g. the index number in the case of the still-picture) and the like, for example. Moreover, the resume information TRSMI has information for indicating a selected stream condition, which includes the system parameters SPRM 10 to 13, for example. Thus, if the resume reproduction is performed during the reproduction in the content space 100CS, the resume information TRSMI is set before the reproduction transition. Then, if the reproduction is restarted in accordance with the resume information TRSMI at the restart of the reproduction, the resume reproduction is performed. For example, during the reproduction of one content, the title menu and the disc menu can be reproduced, and then, the resume reproduction can be performed in the original content.

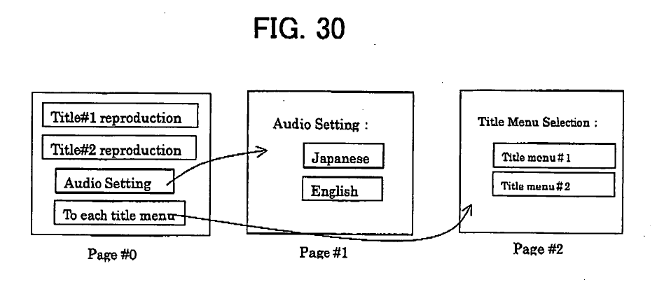

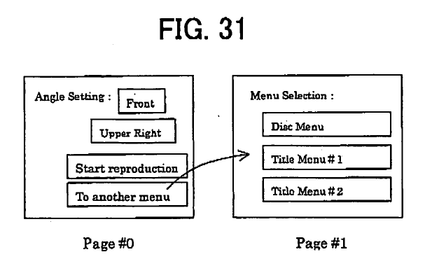

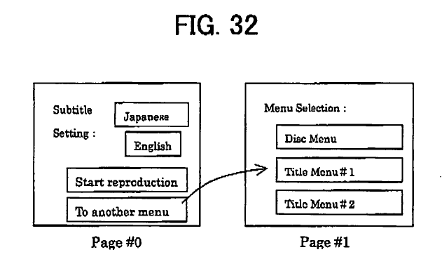

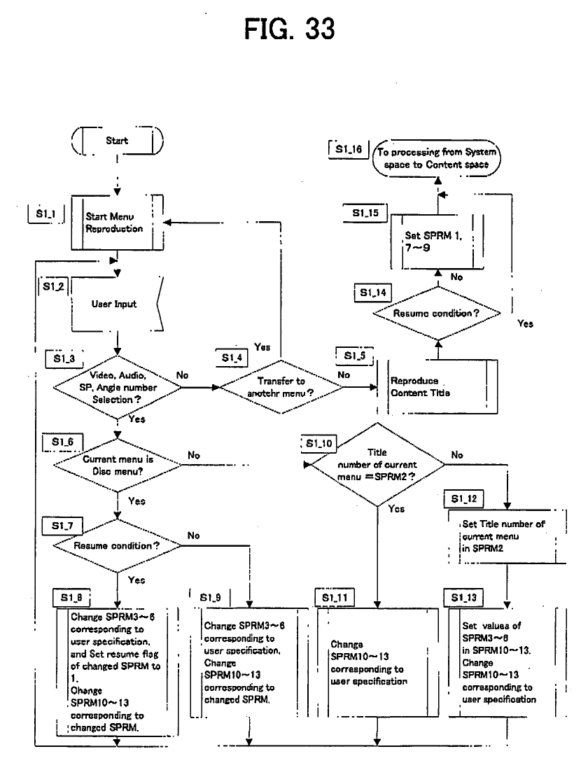

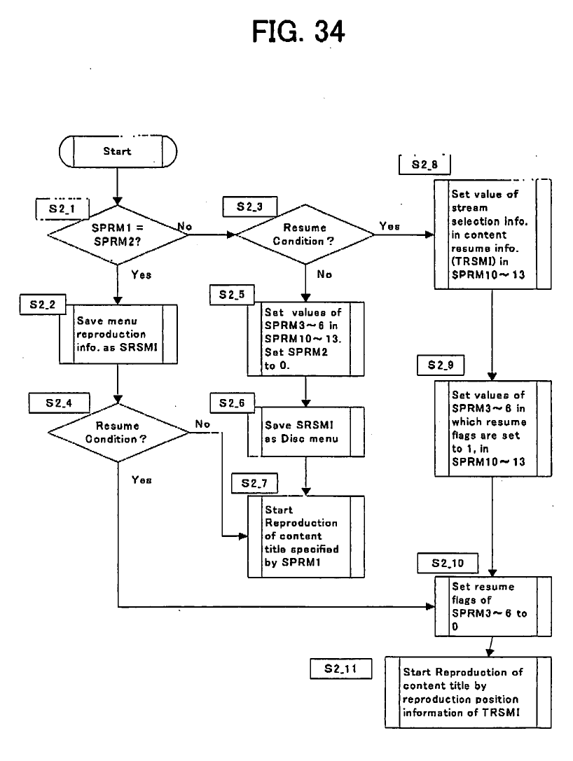

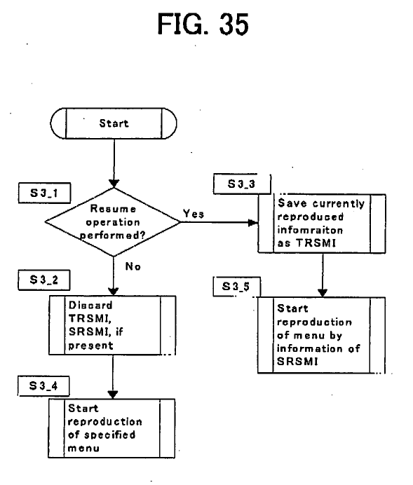

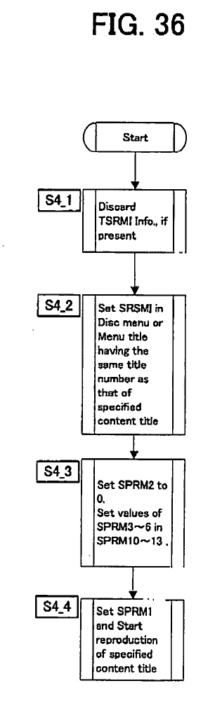

Next, with reference to FIG. 30 to FIG. 36 in addition to FIG. 26, a specific example of a menu screen (i.e. the title menu or the disc menu) actually outputted on the screen of the information record reproduction apparatus 500 on the basis of the system parameters SPRM 1 to 13 will be given, and the operations of the information record reproduction apparatus 500 in performing such a menu display will be explained. FIG. 30 is a conceptual diagram showing a specific display example of the disc menu and its state being changed by menu selection. FIG. 31 is a conceptual diagram showing a specific display example in one title menu and its state being changed by menu selection. FIG. 32 is a conceptual diagram showing a specific display example in another title menu and its state being changed by menu selection. FIG. 33 is a flowchart showing an operational flow in the reproduction transition between the menu domains, in the information record reproduction apparatus 500. FIG. 34 is a flowchart showing an operational flow in the reproduction transition from the system space to the content space, in the information record reproduction apparatus 500. FIG. 35 is a flowchart showing an operational flow in the reproduction transition from the content space to the system space, in the information record reproduction apparatus 500. FIG. 36 is a flowchart showing an operational flow in the reproduction transition between the content domains, in the information record reproduction apparatus 500.

Here, it is assumed for convenience that two titles are recorded on the optical disc 100. Particularly, out of the two titles, the title #1 is a title using multi angles (i.e. a title capable of performing an angle change during reproduction), and the title #2 is a title capable of selecting subtitles with a plurality of languages (i.e. a title capable of performing a subtitle change during reproduction).

At this time, it is considered as follows. The disc menu about both the titles #1 and #2 has a structure shown in FIG. 30. The title menu about the title #1 has a structure shown in FIG. 31. The title menu about the title #2 has a structure shown in FIG. 32.

Namely, as shown in FIG. 30, the disc menu displayed by reproducing the menu domain 1001 (e.g. the menu domain #0) in the system space 100SS shown in FIG. 23, has menu buttons for selecting the reproduction of the title #1 or the title #2, a menu button for audio setting, and a menu button for transition to each title menu, as a page #0 which is its initial screen. For example, if the menu button for audio setting is selected in the condition of the page #0, the display of the disc menu is changed to a page #1 (refer to the middle part of FIG. 30). Then, on the page #1, there are displayed a menu button for selecting Japanese, and a menu button for selecting English, as the audio setting. Here, if “Japanese” or “English” is selected, the corresponding SCP number is set in the system parameter SPRM 5 shown in FIG. 26.

On the other hand, for example, if the menu button for transition to each title menu is selected in the condition of the page #0 in FIG. 30, the display of the disc menu is changed to a page #2 (refer to the right part in FIG. 30). Then, on the page #2, there are displayed a menu button for transition to the title #1, and a menu button for transition to the title #2, as the title menu selection. Incidentally, it is also possible to provide a menu button for returning to the page #0 from the page #1 or the page #2.

As shown in FIG. 31, the title menu for the title #1, displayed by reproducing the menu domain 1001 (e.g. the menu domain #1) in the system space 100CS shown in FIG. 23, i.e. the title menu for angle setting, has two menu buttons for setting the angle on the front or the upper right, a menu button for instructing the start of the reproduction, and a menu button for transition to another menu, as a page #0 which is its initial screen (refer to the left part in FIG. 31). Here, the “front” or “upper right” is selected, the corresponding angle number is set in the system parameter SPRM 13 shown in FIG. 26. Then, for example, if the menu button for transition to another menu is selected in the condition of the page #0, the display of the title menu is changed to a page #1 (refer to the right part in FIG. 31). Then, on the page #1, there are displayed a menu button for transition to the disc menu a menu button for transition to the title menu #1, and a menu button for transition to the title menu #2, as the title menu.

As shown in FIG. 32, the title menu for the title #2, displayed by reproducing the menu domain 1001 (e.g. the menu domain #2) in the system space 100CS shown in FIG. 23, i.e. the title menu for subtitle setting, has two menu buttons for setting the subtitle in Japanese or English, a menu button for instructing the start of the reproduction, and a menu button for transition to another menu, as a page #0 which is its initial screen (refer to the left part in FIG. 32). Here, “Japanese” or “English” is selected, the corresponding SCP number is set in the system parameter SPRM 12 shown in FIG. 26. Then, for example, if the menu button for transition to another menu is selected in the condition of the page #0, the display of the title menu is changed to a page #1 (refer to the right part in FIG. 32). Then, on the page #1, there are displayed a menu button for transition to the disc menu a menu button for transition to the title menu #1, and a menu button for transition to the title menu #2, as the title menu.

Next, processing when the reproduction transition between the menu domains is performed in the various menu displays shown in FIG. 30 to FIG. 32 as described above, will be explained with reference to FIG. 33.

Incidentally, the transition processing between the menu domains, which will be explained here, is performed, as occasion demands, during the selection processing of the title in the step S211 and during the reproduction of the object in the step S216 or the like, in the entire reproduction processing shown in FIG. 19.

In FIG. 33, at first, the menu reproduction is started (step S1_1). Here, if the first play domain 1002 (refer to FIG. 23) is recorded, the title #0 of the corresponding content is reproduced, for example, and then, the disc menu (e.g. the page #0 in FIG. 30) is displayed.

Then, the user input is performed (step S1_2), and it is judged whether or not the user input is an input for specifying video selection, audio selection, sub-picture selection, angle number selection, and the like (step S1_3).

Here, if it is not the input for selecting the angle number and the like (the step S1_3: No), it is judged whether or not the user input is an input for specifying a transfer to another menu (step S1_4). Then, if it is the input for specifying the transfer to another menu (the step S1_4: Yes), the operation flow returns to the step S1_1, and the processing after the user input is repeated.

On the other hand, in the judgment of the step S1_3, if it is the input for selecting the angle number and the like (the step S1_3: Yes), it is further judged whether or not the current menu is the disc menu (step S1_6).

Here, if the current menu is the disc menu (the step S1_6: Yes), it is further judged whether or not to be in the resume condition (step S1_7). Here, whether or not to be in the resume condition is judged in accordance with the remote control operation by a user, for example.

If it is in the resume condition (the step S1_7: Yes), the system parameters SPRM 3 to 6 (refer to FIG. 26) corresponding to the user specification are changed in accordance with the user input. Moreover, the resume flags of the changed system parameters SPRM 3 to 6 are set to 1. Then, the system parameters SPRM 10 to 13 corresponding to the changed system parameters SPRM are further changed (step S1_8).

Then, the operational flow returns to the step S1_1, and the processing after the user input is repeated.

On the other hand, in the judgment of the step S1_7, if it is not in the resume condition (the step S1_7: No), the system parameters 3 to 6 (refer to FIG. 26) corresponding to the user specification are changed in accordance with the user input. Then, the system parameters SPRM 10 to 13 corresponding to the changed system parameters are further changed (step S1_9).

Then, the operational flow returns to the step S1_1, and the processing after the user input is repeated.

On the other hand, in the judgment of the step S1_6, if the current menu is not the disc menu (the step S1_6: No), it is further judged whether or not the title number of the current menu is the “SPRM2” (step S1_10).

Here, if it is the “SPRM2” (the step S1_10: Yes), the system parameters SRPM 10 to 13 corresponding to the user specification are changed (step S1_11).

Then, the operational flow returns to the step S1_1, and the processing after the user input is repeated.

On the other hand, in the judgment of the step S1_10, if the title number of the current menu is not the “SPRM2” (the step S1_10: No), the title number of the current menu is set in the system parameter SPRM 2 (step S1_12). Then, the system parameters 3 to 6 (refer to FIG. 26) corresponding to the user specification are set in the system parameters SPRM 10 to 13. Moreover, the system parameters SPRM 10 to 13 corresponding to the user specification are changed (step S1_13).

Then, the operational flow returns to the step S1_1, and the processing after the user input is repeated.

On the other hand, in the judgment of the step S1_4, if the user input is not the input for specifying the transfer to another menu (the step S1_4: No), the content title is reproduced (step S1_5). Then, it is judged whether or not to be in the resume condition (step S1_14).

Here, if it is not in the resume condition (the step S1_14: No), after the resetting of the system parameters SPRM 1 and 7 to 9 (step S1_15), the processing is transferred to processing from the system space 100SS to the content space 100CS (i.e. processing in FIG. 34) (step S1_16).

Consequently, according to the embodiment, it is possible to efficiently perform the reproduction transition between the menu domains 1001 in the system space 100SS.

Next, processing when the reproduction transition from the system space to the content space is performed in the various menu display shown in FIG. 30 to FIG. 32 as described above, will be explained with reference to FIG. 34.

Incidentally, the transition processing from the system space to the content space, which will be explained here, is performed, as occasion demands, during the selection processing of the title in the step S211 and during the reproduction of the object in the step S216 or the like, in the entire reproduction processing shown in FIG. 19.

In FIG. 34, at first, it is judged whether or not the system parameters SPRM 1 and SPRM 2 are equal (step S2_1).

Here, if the both system parameters are equal (the step S2_1: Yes), menu reproduction information is stored or saved as the resume information for the system space SRSMI (refer to FIG. 28) (step S2_2). Then, it is judged whether or not to be in the resume condition (step S2_4). Here, if it is in the resume condition (the step S2_4: Yes), the resume flags of the system parameters 3 to 6 are set to “0” (step S2_10). Then, in accordance with the reproduction position information of the resume information for the content space TRSMI (refer to FIG. 29), the reproduction of the content title is restarted. Namely, the resume reproduction is performed (step S2_11).

On the other hand, in the judgment of the step S2_1, if the both system parameters are not equal (the step S2_1: No), it is judged whether or not to be in the resume condition (step S2_3). If it is not in the resume condition (the step S2_3: No), the system parameters 3 to 6 corresponding to the user specification (refer to FIG. 26) are set in the system parameters SPRM 10 to 13. Moreover, the value of the system parameter SPRM2 is set to “0” (step S2_5). Then, the resume information for the system space SRSMI is stored as the disc menu (step S2_6).

Following the processing in the step S2_6, or if it is not in the resume condition in the judgment in the step S2_4 (the step S2_4: No), the content title specified with the system parameter SPRM1 is reproduced (step S2_7).

On the other hand, in the judgment of the step S2_3, if it is in the resume condition (the step S_3: Yes), the value of selected stream condition information (refer to FIG. 29) in the resume information for the content space TRSMI is set in the system parameters SPRM 10 to 13 (step S2_8). Moreover, out of the system parameters SPRM 3 to 6, the value of the system parameter in which the resume flag is set to “1”, is set in the system parameters SPRM 10 to 13 (step S2_9). Then, the processing in the step S2_10 and the step S2_11 is performed.

Consequently, according to the embodiment, it is possible to efficiently perform the reproduction transition from the system space 100SS to the content space 100CS.

Next, processing when the reproduction transition from the content space to the system space is performed in the various menu display shown in FIG. 30 to FIG. 32 as described above, will be explained with reference to FIG. 35.

Incidentally, the transition processing from the content space to the system space, which will be explained here, is performed, as occasion demands, during the selection processing of the title in the step S211 and during the reproduction of the object in the step S216 or the like, in the entire reproduction processing shown in FIG. 19.

In FIG. 35, at first, it is judged whether or not a resume operation is to be performed (step S3_1).

Here, if the resume operation is not to be performed (the step S3_1: No), the resume information TRSMI or SRSMI, if present, is discarded (step S3_2). Then, the reproduction of the specified menu is started (step S3_4).

On the other hand, in the judgment of the step S3_1, if the resume operation is to be performed (the step S3_1: Yes), the currently reproduced information is stored as the resume information TRSMI (step S3_3). Then, in accordance with the reproduction position information of the resume information SRSMI (refer to FIG. 28), the reproduction of the menu is restarted. Namely, the resume reproduction is performed (step S3_5)/

Consequently, according to the embodiment, it is possible to efficiently perform the reproduction transition from the content space 100CS to the system space 100SS.

Next, processing when the reproduction transition between the content domains is performed in the various menu display shown in FIG. 30 to FIG. 32 as described above, will be explained with reference to FIG. 36.

Incidentally, the transition processing between the content domains, which will be explained here, is performed, as occasion demands, during the selection processing of the title in the step S211 and during the reproduction of the object in the step S216 or the like, in the entire reproduction processing shown in FIG. 19.

In FIG. 36, at first, the resume information for the content space TRSMI, if present, is discarded (step S4_1).

Then, the resume information SRSMI for the system space is set in the disc menu or the menu title having the same title number as that of the specified content title (step S4_2). Then, the value of the system parameter SPRM2 is set to “0”, and the values of the system parameters SPRM 3 to 6 are set in the system parameters SPRM 10 to 13 (step S4_3).

Then, the system parameter SPRM1 is set, and the reproduction of the specified content title is started (step S4_4).

Consequently, according to the embodiment, it is possible to efficiently perform the reproduction transition between the content domains 1003 in the content space 100CS.

Next, as a specific example of the processing in FIG. 33 to FIG. 36, an explanation is given on processing corresponding to a user operation in which “after the insertion of the optical disc 100 into the information record reproduction apparatus 500, “Japanese” is selected in the audio selection on the disc menu (refer to FIG. 30), and then, the title #1 is reproduced”.

In this case, for example, after the reproduction of the first play domain 1002, the disc menu is reproduced (the step S1_1).

Then, with respect to the disc menu which is the page #0 in FIG. 30, the “audio setting” is selected by the user input (the step S1_2). Then, the page #1 in FIG. 30 is displayed. “Japanese” is further selected by the user. In this case, through the steps S1_3, S1_6, and S1_7 in FIG. 33, the audio index number corresponding to Japanese is set in the system parameters SPRM 4 and 11 (the step S1_9).

Then, the page #0 in FIG. 30 is displayed by the user input, and moreover, the “title #1 reproduction” is specified by the user selection (the step S1_2). Then, through the steps S1_3, S1_4, S1_5, and S1_14, the system parameter SPRM 1 is set to 1 (the steps S1_15 and S1_16). Here, the system parameter SPRM1=1 and the system parameter SPRM2=0, so that the processing in the steps S2_1, S2_3, and S2_5 in FIG. 34 is performed. Incidentally, it is also possible to add judgment processing of “SPRM2=0?” between the step S2_3 and the step S2_5, and make the operational flow diverge to the step S2_6 if “SPRM2=0” (namely, if SPRM2=0, the processing in the step S2_5 may be omitted). Then, the information for indicating the page #0 of the disc menu is stored in the resume information SRSMI (the step S2_6). Then, the reproduction of the title #1 is started by using the value of the system parameter SPRM 11 (the step S2_7). Incidentally, here, default values are used for the system parameters SPRM 10, 12, and 13.

Next, as a specific example of the processing in FIG. 33 to FIG. 36, an explanation is given on processing corresponding to a user operation in which “after the resume is performed during the reproduction of the title #1 and then the angle is changed to the “upper right” on the title menu #1, the audio is changed to “English” on the disc menu, and further the reproduction of the title “#1 is restarted”.

In this case, the resume is performed by the user specification (the step S3_1), and the resume information TRSMI is held (the step S3_3). Then, in accordance with the resume information SRSMI, the display of the disc menu is started (the steps S3_5 and S1_1).

Then, with respect to this disc menu, the title menu #1 is displayed by the user specification (the steps S1_2, S1_3, S1_4, and S1_1). Moreover, the “upper right” angle is selected by the user. Then, after the steps S1_2, S1_6, and S1_10, the system parameter SPRM2 is set to “1” by the processing in the step S1_12. Moreover, in the processing in the step S1_13, the angle number corresponding to the “upper right” is set in the system parameter SPRM 13.

Then, the disc menu is displayed by the user specification (the steps S1_2, S1_3, S1_4, and S1_1). In this specific example, the “audio setting” is selected, so that the page #1 in FIG. 30 is displayed. In the specific example, “English” is selected by the user in the “audio setting” (the steps S1_2 and S1_3). Then, after the processing in the steps S1_6 and S1_7, the resume flag in the system parameter SPRM 4 is set to “1”. Before or after this, the audio index number corresponding to English is set in the system parameters SPRM 4 and SPRM 11 (the step S1_8).

Then, the restart of reproducing the title #1 is instructed by the user (the step S1_2), and after the processing in the steps S1_3, S1_4, S1_5, S1_14, S1_16, and S2_1, the resume information SRSMI is stored as the disc menu (the step S2_2). Then, after the processing in the step S2_4, the resume flag of the system paramter SPRM4 is set to “0” (the step S2_10). Then, the reproduction is started by the reproduction position information in the resume information TRSMI (the step S2_11). Namely, the resume reproduction is performed.

Next, as a specific example of the processing in FIG. 33 to FIG. 36, an explanation is given on processing corresponding to a user operation in which “the resume is performed during the reproduction of the title #1, the audio is changed to “Japanese” on the disc menu, the “front” is selected in the angle on the title menu #1, the subtitle is changed to “English” on the title menu #2 since the user wants to watch the title #2, and after all, the user wants to watch the title #1 from where the user left off, so that the reproduction of the title #1 is restarted”.

In this case, the resume is performed by the user specification (the step S3_1), and the resume information TRSMI is held (the step S3_3). Then, in accordance with the resume information SRSMI, the display of the disc menu is started (the steps S3_5 and S1_1).

Then, in this specific example, the “audio setting” is selected, so that the page #1 in FIG. 30 is displayed. Moreover, “Japanese” is selected by the user in the “audio setting” (the steps S1_2 and S1_3), and after the processing in the steps S1_6 and S1_7, the resume flag in the system parameter SPRM4 is set to “1”. Before or after this, the audio index number corresponding to “Japanese” is set in the system parameters SPRM 4 and SPRM 11 (the step S1_8).

Then, the page #0 is displayed by the instruction from the user, and “to another menu” is selected, to thereby display the page #2 in FIG. 30. Here, the title menu #1 is displayed by the user selection (the steps S1_2, S1_3, S1_4, and S1_1). In this specific example, the “front” angle is further selected by the user. After the processing in the steps S1_2, S1_6, and S1_10, the angle number corresponding to the “front” is set in the system parameter SPRM 13 by the processing in the step S1_11.

Then, if “to another menu” is selected, as shown in FIG. 31, the page #1 of the title menu #1 is displayed. Here, the “title menu #2” is selected, by which the page #0 of the title #2 is displayed as shown in FIG. 32 (the steps S1_2, S1_3, S1_4, and S1_1). Here, if “English” is further selected by the user (the step S1_2), a value of “2” is set in the system parameter SPRM2 after the processing in the steps S1_3, S1_6, and S1_10 (the step S1_12). Then, the values of the system parameters SPRM 3 to 6 are set in the system parameters SPRM 10 to 13, respectively, and the SCP number corresponding to the English subtitles is set in the system parameter SPRM 12 (the step S1_13).

Then, if the restart of reproducing the title #1 is instructed by the user (the step S1_2), the selected stream condition information in the resume information TRSMI is set in the system parameters SPRM 10 to 13, after the processing in the steps S1_3, S1_4, S1_5, S1_14, S1_16, S2_1, and S2_3 (the step S2_8). Moreover, the value of the system parameter SPRM 4 is set in the system parameter SPRM 11 (the step S2_9). Before or after this, the resume flag of the system parameter SPRM 4 is set to “0” (the step S2_10). Then, in accordance with the reproduction position information of the resume information TRSMI, the reproduction is started (the step S2_11). Namely, the above processing enables a change to the Japanese sound and the restart of the reproduction.

As explained in detail with reference to FIG. 20 to FIG. 36, according to the embodiment, it is possible to perform the reproduction transition between the content domains 1003 in the content space 100CS, the reproduction transition between the menu domains 1001 in the system space 100SS, and particularly, the reproduction transition between the menu domain 1001 associated with the individual content in the system space 100SS and the menu domain 1001 associated with the entire optical disc 100, quickly and easily.

(Access Flow in Reproducing)

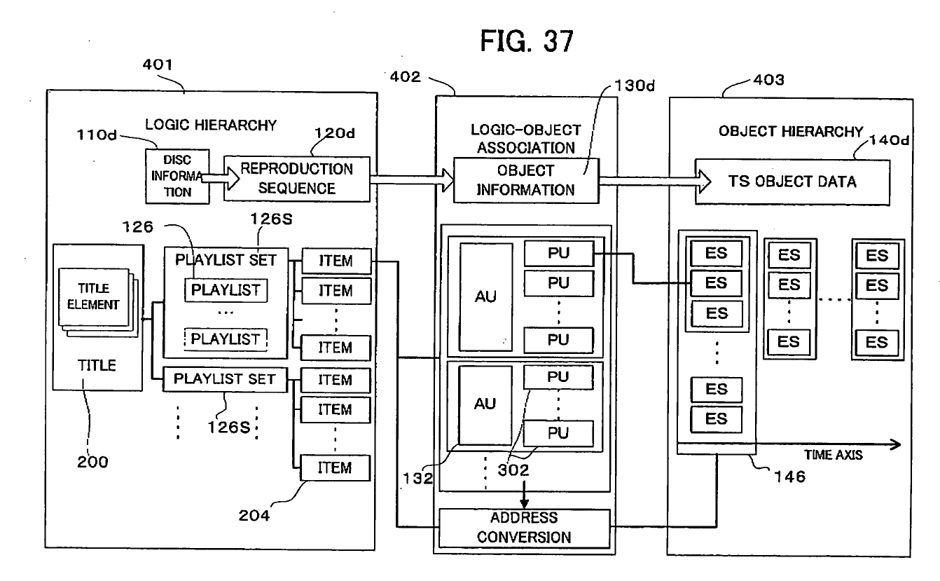

Next, with reference to FIG. 37, the flow of the access in reproducing at the information record/reproduction apparatus 500, which uses the AU information 132 and the PU information 302, as one of the features of this embodiment, will be explained as well as the logical structure of the optical disc 100. FIG. 37 conceptually shows an entire access flow in reproducing, in relation to the logical structure of the optical disc 100.

In FIG. 37, the logical structure of the optical disc 100 is categorized broadly into the following three hierarchies: a logical hierarchy 401; an object hierarchy 403; and a logic-object associating hierarchy 402 mutually associating those two hierarchies.

Among them, the logical hierarchy 401 is a hierarchy that logically specifies various logical information to reproduce the desired title upon reproducing, as well as the play list (P list) to be reproduced and its construction content. In the logical hierarchy 401, disc information 110d, indicating the entire titles 200 and the like on the optical disc 100, is written within the disc information file 110 (refer to FIG. 3), and further, reproduction sequence information 120d of the entire contents on the optical disc 100 is written within the play list information file 120 (refer to FIG. 3). More specifically, the construction of one or a plurality of play lists 126S is written for one or a plurality of title elements 200-2 included in each title 200, as the reproduction sequence information 120d. Moreover, each play list set 126S includes one or a plurality of play lists 126, and the construction of one or a plurality of Items 204 (refer to FIG. 13) is written in each play list 126. Then, in accessing at the time of the reproduction, the logical hierarchy 401 as described above specifies the title 200 to be reproduced, the play list 126 corresponding to this, and further the Item 204 corresponding to this.

Then, the logic-object associating hierarchy 402 is a hierarchy that specifies the attribute and the physical storage address of the TS object data 140d to be reproduced, so as to specify the combination and/or the construction of the TS object data 140d as being the entity data, and perform an address conversion to the object hierarchy 403 from the logical hierarchy 401, on the basis of the information specified in the logical hierarchy 401 as described above. More specifically, in the logic-object associating hierarchy 402, the object information data 130d, which separates a group of the contents constituting each Item 204 into units of the AU 132 and which finely separates each AU 132 into units of the PU 302, is written in the object information file 130 (refer to FIG. 3).

Here, “the PU (Presentation Unit) 302” is a unit of associating and grouping a plurality of elementary streams for each reproduction-changing unit. If there are three audio streams in this PU 302, the user can also freely change three audios (e.g. audios in different languages and the like) while reproducing this vision.

On the other hand, “the AU (Associate Unit) 132” is a unit of associating or grouping a plurality of elementary streams, such as the video stream, in the TS object used in one title, and is one of a group of a plurality of PUs 302. More specifically, the AU 132 is a unit of grouping the elementary stream packet ID (ES_PID) for each TS object, indirectly through the PU 302. This AU 132 corresponds to a group of a plurality of shows or programs that mutually has a special relationship in considering the contents, for example, such as a plurality of shows or programs mutually changeable in multiple broadcasting and the like. Then, the PU 302, which belongs to the same AU 132, corresponds to one or a group of a plurality of elementary streams which constitutes a plurality of shows or programs that is mutually changeable by the user operation upon reproducing.

Therefore, if the AU 132 to be reproduced is specified, and moreover, the PU 302 which belongs to the AU 132 is specified, then the elementary stream to be reproduced is specified. Namely, even if the PAT and the PMT shown in FIG. 12 are not used, it becomes possible to reproduce the desired elementary stream from among the multiplexed and recorded elementary streams from the optical disc 100.

Incidentally, the more specific data structure of the AU information 132I and the PU information 302I, which respectively define the AU 132 and the PU 302 described above, will be described in detail later.

Here, the elementary stream that is actually reproduced is identified or specified by the ES_PID, which is the packet ID of the elementary stream (refer to FIG. 12), from the PU information 302I. At the same time, by converting the information for indicating the reproduction start time point and end time point, into the address information of the elementary stream, the contents in a specific area (or a specific time range) of a specific elementary stream are reproduced.

In this manner, in the logic-object associating hierarchy 402, the address conversion to the physical address related to each PU 302 from the logical address related to each Item 204 is executed.

Then, the object hierarchy 403 is a physical hierarchy for reproducing the actual TS object data 140d. In the object hierarchy 403, the TS object data 140d is written within the object data file 140 (refer to FIG. 3). More specifically, the TS packets 146 constituting a plurality of elementary streams (ES) are multiplexed at each time point, and the arrangement of the TS packets 146 along the time axis enables a plurality of elementary streams to be constructed (refer to FIG. 11). Then, the plurality of TS packets 146 multiplexed at each time point are associated with the PU 302 identified at the logic-object associating hierarchy 402, for each elementary stream. Incidentally, it is also possible to associate a plurality of PUs 302 with one elementary stream (e.g. to share the elementary stream related to the same audio data and/or the elementary stream related to the same sub picture data, among a plurality of changeable shows or programs).

In this manner, in the object hierarchy 403, the object data is actually reproduced, by using the physical address obtained by the conversion at the logic-object associating hierarchy 402.

As described above, the three hierarchies shown in FIG. 37 allow the execution of the access with respect to the optical disc 100 in reproducing.

(Structure of Object Information File)

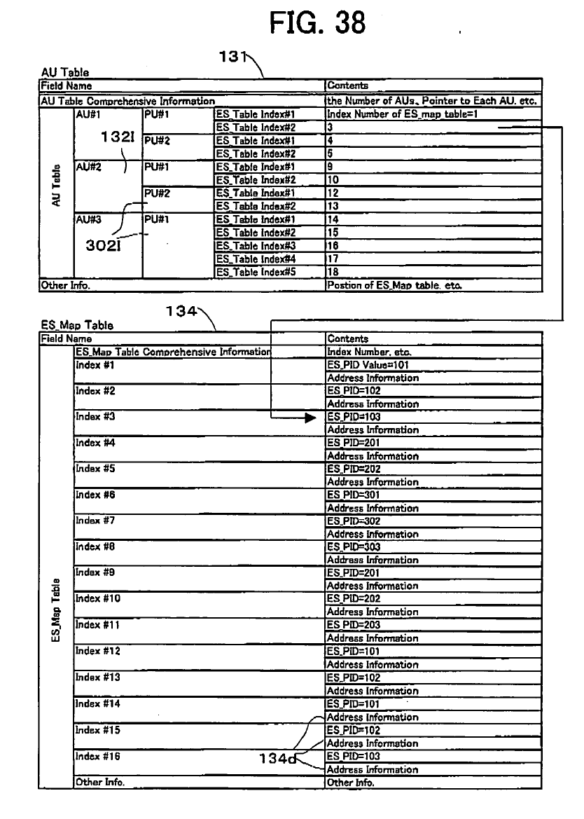

Next, with reference to FIG. 38, one specific example of a data structure in the object information file 130, which associates the various logical information in the disc information file 110 and the play list information file 120 with the object data in the object data file, as explained in FIG. 37, will be explained. FIG. 38 schematically shows one specific example of the data structures of the AU (Associate Unit) table 131 (refer to FIG. 3) constructed in the object information file 130 and the ES (Elementary Stream) map table 134 (refer to FIG. 3) related to the AU table 134.

In this specific example, as shown in FIG. 38, the object information table is stored in the object information file 130. The object information table is provided with the AU table 131 shown in the upper part of FIG. 37 and the ES map table 134 shown in the lower part.

In the upper part of FIG. 38, the AU table 131 may have a structure that allows the required number of tables for each Field to be added. For example, if there are four AUs, it may have such a structure that the number of the Fields increases to four.

In the AU table 131, there are stored “AU table comprehensive information” in which the number of AUs and the pointer to each AU, and the like are written, and “the other information.”

The AU table 131 describes therein the Index number (Index number= . . . ) of the corresponding ES map table 134, as the AU information 1321 which indicates an ES table Index #m in each PU #m corresponding to each AU #n. Here, the “AU” is a unit corresponding to a “show” in TV broadcast, for example, as mentioned above (especially, in the case of “multi-vision” broadcasting, it is a unit of a group of a plurality of “visions” which is changeable or selectable), and it includes one or more PUs, each of which is a reproduction unit. Moreover, the “PU” is a group of mutually changeable elementary streams which are included in each AU, as described above, and the ES table Index #m corresponding to each PU is specified by the PU information 302I. For example, if multi-view contents are provided with the AU, the AU stores therein a plurality of PUs, and each PU stores therein the pointers to a plurality of elementary stream packet IDs which indicates the packets constituting the contents of each view. This indicates the Index number in the ES map table 134, as described later.

In the lower part of FIG. 38, in the ES map table 134, there are stored ES map table comprehensive information, a plurality of Indexes #m (m=1, 2, . . . ), and the “other information”, for each Field.

The “ES map table comprehensive information” describes therein the size of the ES map table, the total number of Indexes, and the like.

The “Index #m” includes the elementary stream packet ID (ES_PID) of the entire elementary stream to be used for the reproduction, the corresponding Index number, and the address information of the elementary stream.

In the embodiment, for example, if the elementary stream is the video stream of the MPEG 2 as described above, only the TS packet number of the TS packet at the head of the I picture, and the corresponding display time length are written, as the address information, i.e. the ES address information 134d, on the ES map table 134, by which the data amount is tried to be reduced.

Because of the construction as described above, it is possible to obtain the elementary stream packet ID (ES_PID) of the actual elementary stream, from the Index number of the ES map 134 specified from the AU table 131. Moreover, since the address information of the elementary stream corresponding to the elementary stream packet ID can be obtained at the same time, it is possible to reproduce the object data on the basis of these information.

According to the data structure of the optical disc 100 explained above, even in adding a new title to the optical disc 100, necessary information can be easily added, which is useful. On the other hand, even if some information becomes unnecessary as a result of editing or the like, for example, what is to be done is simply not to refer to the information, and it is not necessary to actually delete the information from the table, which is useful, as well.

As explained in detail with reference to FIG. 1 to FIG. 38, according to the embodiment, it is possible to perform the reproduction transition between the domains in the content space and in the system space, quickly and simply.

Incidentally, the optical disc 100 as one example of the information record medium, and a recorder or a player related to the optical disc 100 as one example of the information record/reproduction apparatus are explained in the above described embodiment; however, the present invention is not limited to the optical disc, and the recorder or the player thereof. The present invention is available for the other various information record/reproduction media corresponding to the high density recording or the high transmission rate, and their recorders or players.

The present invention is not limited to the above-described embodiments, and changes may be made if desired without departing from the scope or spirit of the invention which can be read from the claims and the entire specification. An information record medium, an apparatus for and a method of recording the information, an apparatus for and a method of reproducing the information, an apparatus for and a method of recording and reproducing the information, a computer program for controlling the record or the reproduction, and a data structure including a control signal that accompany such changes are also intended to be within the technical scope of the present invention.

### INDUSTRIAL APPLICABILITY

An information record medium, a apparatus for and a method of recording the information, an apparatus for and a method of reproducing the information, an apparatus for and a method of recording and reproducing the information, a computer program for controlling the record or the reproduction, and a data structure including a control signal that are associated with the present invention, can be applied to a high-density optical disc for consumer or industrial use, such as a DVD, on which various information, such as the video information, the audio information, the sub picture information, and the reproduction control information, can be recorded at high density, and further can be applied to a DVD player, a DVD recorder, and the like. Moreover, they can be applied to an information record medium, an information record/reproduction apparatus, or the like, which are inserted in or can be connected to various computer equipment for consumer or industrial use, for example.

1. An information record medium, comprising:
a content space in which a plurality of content domains are recorded and which occupies one area in a recording area of said information record medium, each content domain being constructed from a series of content information; and
a system space in which a plurality of menu domains corresponding to the plurality of content domains are recorded and which occupies a different area from said content space in the recording area, each menu domain being constructed from menu information as for the content information,
another menu domain being recorded in said system space, in addition to the plurality of menu domains, the another menu domain being constructed from menu information as for whole of the plurality of content domains or as for whole of said information record medium.

2. The information record medium according to claim 1, wherein a content domain for first play, which is reproduced in an initial stage of a reproduction operation, is further recorded in said system space.

3. The information record medium according to claim 1, wherein the content information is multiplexed and recorded by a unit of packet, which is a physically accessible unit and by which a piece of the content information is individually stored, as the content domain.

4. The information record medium according to claim 1, wherein the menu information as for the whole is constructed from information for commonly performing selection or setting regarding a plurality of video information or audio information, which constitutes the content information, on the whole of said information record medium.

5. The information record medium according to claim 1, wherein the menu information as for the content information is constructed from information for performing selection or setting regarding a plurality of video information or audio information, which constitutes the content information, only with respect to the content information.

6. The information record medium according to claim 1, wherein a plurality of titles recorded on said information record medium individually comprise one of the content domains and one of the menu domains, and
one of the plurality of titles comprises the another menu domain and a content domain for first play.

7. An information record apparatus, comprising:
a first recording device for recording a plurality of content domains into a content space which occupies one area in a recording area of an information record medium, each content domain being constructed from a series of content information; and
a second recording device for recording a plurality of menu domains corresponding to the plurality of content domains into a system space which occupies a different area from said content space in the recording area, each menu domain being constructed from menu information as for the content information,
said second recording device recording another menu domain into said system space, in addition to the plurality of menu domains, the another menu domain being constructed from menu information as for whole of the plurality of content domains or as for whole of said information record medium.

8. An information record method, comprising:
a first recording process of recording a plurality of content domains into a content space which occupies one area in a recording area of an information record medium, each content domain being constructed from a series of content information; and
a second recording process of recording a plurality of menu domains corresponding to the plurality of content domains into a system space which occupies a different area from said content space in the recording area, each menu domain being constructed from menu information as for the content information,
said second recording process recording another menu domain into said system space, in addition to the plurality of menu domains, the another menu domain being constructed from menu information as for whole of the plurality of content domains or as for whole of said information record medium.

9. An information reproduction apparatus for reproducing information on said information record medium according to claim 1, said information reproduction apparatus comprising:
a reproducing device for reproducing the content domain from said content space and reproducing the plurality of menu domains or the another menu domain from said system space;
a setting device capable of externally setting a system parameter correspondingly to the reproduced plurality of menu domains or the reproduced another menu domain; and
a controlling device for controlling said reproducing device to reproduce the content domain, in accordance with the system parameter externally set by said setting device.

10. The information reproduction apparatus according to claim 9, wherein the system parameter includes: one or a plurality of first system parameters, which are set correspondingly to the plurality of menu domains; one or a plurality of second system parameters, which are set correspondingly to the another menu domain; and a third system parameter for indicating a content domain which is a setting object of the first system parameter.

11. The information reproduction apparatus according to claim 10, wherein the third system parameter indicates that the first system parameter is not set, by virtue of its particular value.

12. The information reproduction apparatus according to claim 10, wherein
the second system parameter includes a resume flag for indicating whether or not the second system parameter is changed in the another menu domain if the reproduction of the content domain is restarted by resume reproduction, and
said controlling device controls said reproducing device to perform the resume reproduction of the content domain, on the basis of the resume flag.

13. The information reproduction apparatus according to claim 10, wherein
the system parameter further includes a fourth system parameter for indicating a content domain which is being currently reproduced by said reproducing device, and
said controlling device controls said reproducing device to reproduce the content domain on the basis of the first system parameter, if the content domain indicated by the third system parameter agrees with the content domain indicated by the fourth system parameter

14. An information reproduction method of reproducing information on said information record medium according to claim 1, said information reproduction method comprising:
a reproducing process of reproducing the content domain from said content space and reproducing the plurality of menu domains or the another menu domain from said system space; and
a controlling process of controlling said reproducing process to reproduce the content domain, in accordance with a system parameter externally set by said setting device capable of externally setting the system parameter correspondingly to the reproduced plurality of menu domains or the reproduced another menu domain.

15. An information record reproduction apparatus, comprising:
a first recording device for recording a plurality of content domains into a content space which occupies one area in a recording area of an information record medium, each content domain being constructed from a series of content information;
a second recording device for recording a plurality of menu domains corresponding to the plurality of content domains into a system space which occupies a different area from said content space in the recording area, each menu domain being constructed from menu information as for the content information,
said second recording device recording another menu domain into said system space, in addition to the plurality of menu domains, the another menu domain being constructed from menu information as for whole of the plurality of content domains or as for whole of said information record medium;
a reproducing device for reproducing the content domain from said content space and reproducing the plurality of menu domains or the another menu domain from said system space;
a setting device capable of externally setting a system parameter correspondingly to the reproduced plurality of menu domains or the reproduced another menu domain; and
a controlling device for controlling said reproducing device to reproduce the content domain, in accordance with the system parameter externally set by said setting device.

16. An information record reproduction method, comprising:
a first recording process of recording a plurality of content domains into a content space which occupies one area in a recording area of an information record medium, each content domain being constructed from a series of content information;
a second recording process of recording a plurality of menu domains corresponding to the plurality of content domains into a system space which occupies a different area from said content space in the recording area, each menu domain being constructed from menu information as for the content information,
said second recording process recording another menu domain into said system space, in addition to the plurality of menu domains, the another menu domain being constructed from menu information as for whole of the plurality of content domains or as for whole of said information record medium;
a reproducing process of reproducing the content domain from said content space and reproducing the plurality of menu domains or the another menu domain from said system space; and
a controlling process of controlling said reproducing process to reproduce the content domain, in accordance with a system parameter externally set by said setting device capable of externally setting the system parameter correspondingly to the reproduced plurality of menu domains or the reproduced another menu domain.

17. A computer program for controlling record which controls a computer provided in said information record apparatus according to claim 7 and which causes the computer to function as at least one portion of said first recording device and said second recording device.

18. A computer program for controlling reproduction which controls a computer provided in said information reproduction apparatus according to claim 9 and which causes the computer to function as at least one portion of said reproducing device, said setting device, and said controlling device.

19. A computer program for controlling record and reproduction which controls a computer provided in said information record reproduction apparatus according to claim 15 and which causes the computer to function as at least one portion of said first recording device, said second recording device, said reproducing device, said setting device, and said controlling device.

20. A data structure including a control signal, comprising
a content space in which a plurality of content domains are recorded and which occupies one area in a recording area of said information record medium, each content domain being constructed from a series of content information; and
a system space in which a plurality of menu domains corresponding to the plurality of content domains are recorded and which occupies a different area from said content space in the recording area, each menu domain being constructed from menu information as for the content information,
another menu domain being recorded in said system space, in addition to the plurality of menu domains, the another menu domain being constructed from menu information as for whole of the plurality of content domains or as for whole of said information record medium.
